(19) United States
(12) Patent Application Publication
(10) Pub. No.: US 2015/0169267 A1
(43) Pub. Date: Jun. 18, 2015

(54) INFORMATION PROCESSING APPARATUS, INFORMATION PROCESSING METHOD, AND COMPUTER PROGRAM

(71) Applicant: CANON KABUSHIKI KAISHA, Tokyo (JP)

(72) Inventor: Satoshi Hirakawa, Fuchu-shi (JP)

(21) Appl. No.: 14/557,566

(22) Filed: Dec. 2, 2014

(30) Foreign Application Priority Data
Dec. 16, 2013 (JP) 2013-259445
Jul. 2, 2014 (JP) 2014-137015

(51) Int. Cl. G06F 3/12; G06K 15/00; H04N 1/00

(52) U.S. Cl. CPC G06F 3/1225; G06F 3/1205; G06F 3/1206; G06F 3/1226; G06F 3/1228; G06F 3/1232; H04N 1/00408; H04N 1/00474; G06K 15/005; H04N 2201/0094

(57) ABSTRACT

A printer name and a basic capability are obtained from a printer which was searched for when installing a printer driver, and a device type of the printer is decided from the obtained printer name and basic capability and a matching table. Setting information of the decided device type is reflected to configuration settings, and a print setting screen based on the configuration settings is provided.

### BACKGROUND OF THE INVENTION

1. Field of the Invention

The present invention relates to an information processing apparatus, an information processing method, and a computer program and, more particularly, the invention is suitable when it is used to control a plurality of kinds of image forming apparatuses having different functions.

2. Description of the Related Art

There is a printer driver called a universal printer driver as a printer driver (control command generating program) to control a plurality of kinds of image forming apparatuses having different functions. There is a technique regarding such a printer driver. The Official Gazette of Japanese Patent Application Laid-Open No. 2011-243067 discloses such a technique that a model name of a printer and a printing function which can be used in such a model are stored so as to correspond to each other and a setting display screen for enabling the usable printing function to be selected in accordance with the model name of the printer which is connected to an information processing apparatus is provided.

However, the printer driver disclosed in the Official Gazette of Japanese Patent Application Laid-Open No. 2011-243067 has the following problem. That is, although the printer driver disclosed in the Official Gazette of Japanese Patent Application Laid-Open No. 2011-243067 has a printing function of the printer of the well-known model name, it does not have a printing function about a printer of a model name which will be put on sale in future. Therefore, according to the technique disclosed in the Official Gazette of Japanese Patent Application Laid-Open No. 2011-243067, for example, with respect to the printer having the model name which will be put on sale in future, that is, a printer having unknown specifications, only the printing function which a general printer has can be provided.

### SUMMARY OF THE INVENTION

The invention is made in consideration of such a problem and it is an aspect of the invention to enable a function of an image forming apparatus having unknown specifications to be supported by a universal printer driver as much as possible.

According to an aspect of the invention, there is provided an information processing apparatus having an installing unit configured to install a device driver for generating control commands to a plurality of kinds of image forming apparatuses having different functions, wherein: the installing unit has a deciding unit configured to decide a kind of the image forming apparatus connected so that it can communicate, a selecting unit configured to select device configuration type information corresponding to the decided kind of the image forming apparatus, and a setting unit configured to set the selected device configuration type information; and the device configuration type information includes information of functions which can be used in the image forming apparatus.

Further features of the present invention will become apparent from the following description of exemplary embodiments with reference to the attached drawings.

### BRIEF DESCRIPTION OF THE DRAWINGS

FIG. 1 is a diagram illustrating a whole construction of a print system.

FIG. 2 is a diagram illustrating a hardware construction of a host computer and a printer.

FIG. 3 is a diagram illustrating a software construction of the host computer.

FIGS. 4A, 4B, 4C and 4D are diagrams illustrating a configuration setting screen.

FIGS. 5A, 5B, 5C and 5D are diagrams illustrating a processing capability of a paper size.

FIGS. 6A and 6B are diagrams illustrating a printing setting screen.

FIG. 7 is a diagram illustrating setting information of device types.

FIGS. 8A and 8B are diagrams illustrating a configuration setting screen of “Anywhere Print” or the like.

FIG. 9 is a flowchart illustrating a process for changing configuration settings in a batch manner.

FIG. 10 is a flowchart illustrating an installing process of a driver.

FIG. 11 is a diagram illustrating a matching table.

FIG. 12, which is composed of FIGS. 12A and 12B, is a flowchart illustrating the installing process of the driver.

FIGS. 13A and 13B are diagrams illustrating mapping information and a matching table after updating.

FIG. 14 is a diagram illustrating a display screen which is provided by a driver installer.

FIG. 15 is a diagram illustrating a display screen which is provided by the driver installer.

FIG. 16 is a diagram illustrating a display screen which is provided by the driver installer.

FIG. 17 is a diagram illustrating a display screen which is provided by a printer driver.

FIG. 18 is a flowchart illustrating the installing process of the driver.

FIG. 19 is a diagram illustrating setting information of device types.

FIG. 20 is a diagram illustrating a configuration setting screen.

### DESCRIPTION OF THE EMBODIMENTS

Embodiments of the invention will be described hereinbelow with reference to the drawings.

In the embodiments which will be described hereinbelow, a plurality of kinds of printers (image forming apparatuses) having different functions are controlled by a universal printer driver (device driver). For this purpose, in the universal printer driver, a capability of each model is not included in a database but all capabilities including a capability which is specific or inherent to a model are set on the basis of configuration settings. In other words, in addition to a capability (basic capability) which a general printer has, a capability (specific capability) which is specific or inherent to the model is also set to a target of the configuration settings. A printing setting screen is not constructed on the basis of information of a function of the printer stored in an internal database but is constructed on the basis of information set by the configuration settings. In the embodiment, a universal printer driver which can support the function of the printer as much as possible even to the printer having unknown specifications is realized.

First, terminologies which are used in the embodiment of the invention will be defined.

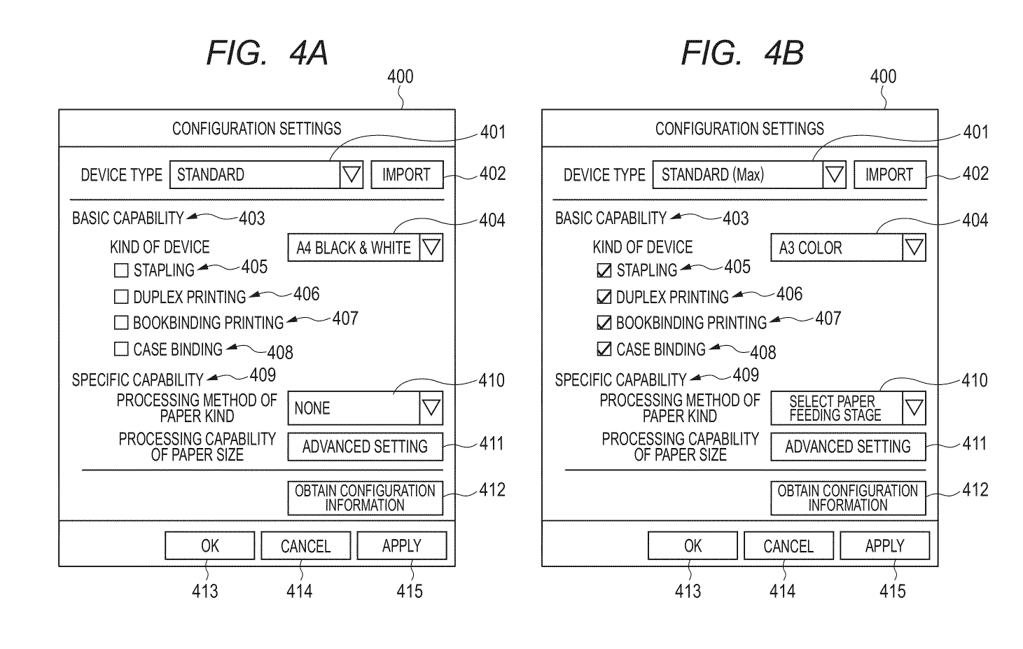

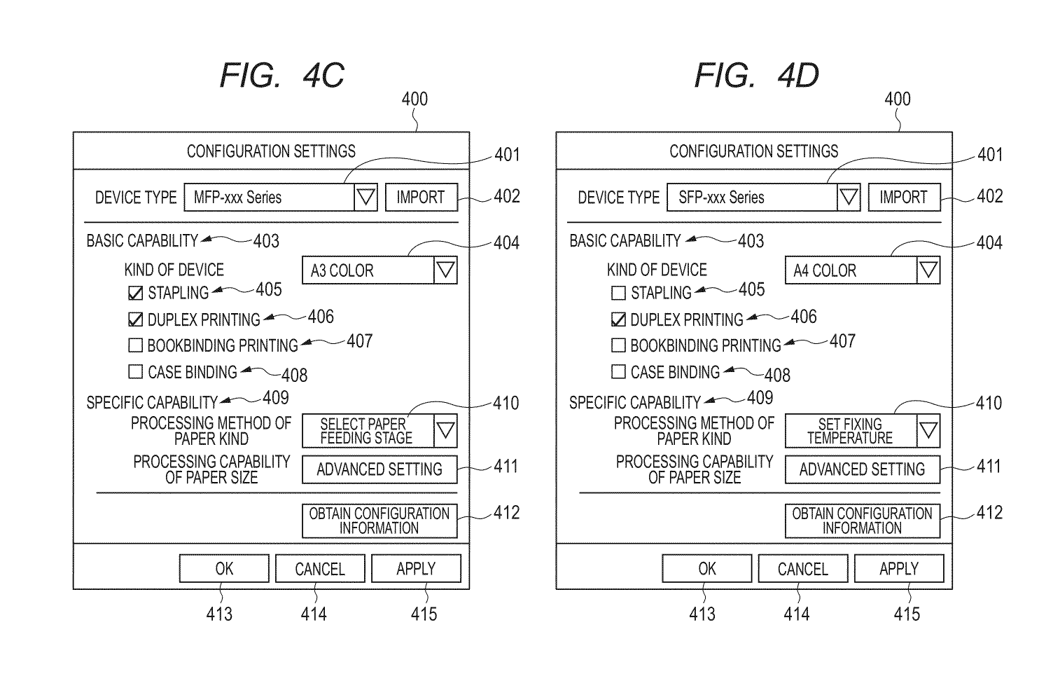

“capability” denotes a function which can be used in a printer connected to an information processing apparatus so that it can communicate therewith or a setting item of the function in the configuration setting screen. For example, in the case where a duplex unit or the like is mounted in the printer connected to the information processing apparatus so that it can communicate therewith and the printer can perform <duplex printing>, it is regarded that the printer has a capability of <duplex printing>. In this case, the setting item of the capability of <duplex printing> exists on the configuration setting screen, which will be described hereinafter (refer to a check box 406 to select the duplex printing in FIGS. 4A to 4D).

“configuration settings” denotes settings of the functions which can be used in the printer connected to the information processing apparatus so that it can communicate therewith. Specifically speaking, for example, “configuration settings” denotes settings such as use availability of the duplex printing, use availability of the bookbinding printing, and the like. The functions which were enabled to be used by the configuration settings can be designated in “printing settings” which is made every print job. For example, if <duplex printing> can be used by the configuration settings (that is, if the capability of <duplex printing> is turned on (valid) on the configuration setting screen), in addition to <simplex printing>, <duplex printing> can be designated on the printing setting screen.

“maximum capability” denotes all capabilities which can be supported by the printer connected to the information processing apparatus so that it can communicate therewith by mounting an optional device or the like.

“current capability” denotes a capability which can be used at present by the printer connected to the information processing apparatus so that it can communicate therewith by using the optional device or the like which has actually been mounted. The printing settings which are made every print job can be performed within a range of the current capability. The printing setting screen is also formed on the basis of the current capability. A flow by which the printing setting screen is formed on the basis of the current capability will be described hereinafter.

“basic capability” denotes a capability of a general printer such as duplex printing, stapling, or the like. In a printer of a model in which the basic capability can be used by mounting the optional device or the like, the basic capability is manually set by the configuration settings or the basic capability is set by obtainment of configuration information (basic capability) from the printer. “basic capability” corresponds to a basic capability of such a printer that a device type, which will be described hereinbelow, is decided. “specific capability” denotes a fixed capability which is specific or inherent to the model. In many cases, “specific capability” is not set by the obtainment of the configuration information from the printer.

For example, there is a case where the contents designated by “a processing method of <paper kind>” on the printing setting screen are used for designation of a fixing mode in a printer of a certain model and are used for selection of a paper feeding stage in a printer of another model.

The fixing mode is constructed by a combination of a temperature setting of a fixing drum and a paper feeding speed. For example, <thick paper> is selected in <paper kind>, a process for raising the fixing temperature and reducing the paper feeding speed as compared with those in the case where <plain paper> is selected is executed.

The selection of the paper feeding stage is such a function that when <plain paper> is selected, a cassette in which plain paper has been set is automatically selected, and when <thick paper> is selected, a cassette in which thick paper has been set is automatically selected.

On the printing setting screen, <thick paper> or <OHP> can be selected in “paper kind” in any case. However, which one of the process of the fixing mode and the process of the selection of the paper feeding stage is executed has been predetermined every printer. It is, therefore, necessary to generate a suitable print job (command) every printer.

As another example of “specific capability”, there is “processing capability of paper size”.

The processing capability of the paper size is a processing capability of each model showing “which paper size is available?”, “duplex printing is available in each paper size?”, “at which position stapling can be performed?”, or the like. Those processing capabilities differ every model and cannot be obtained in the configuration information from the printer in many cases. It is also more difficult to set the specific capability on the configuration setting screen as compared with the setting of the basic capability or the like. As mentioned above, differences of fine operations of the individual printers which cannot be fully set by the obtainment of the configuration information are included in “specific capability” and there are many capabilities which are difficult to be set by the user.

The embodiments of the invention will be described by defining the foregoing meanings of the terminologies as a prerequisite.

### First Embodiment

First, the first embodiment will be described.

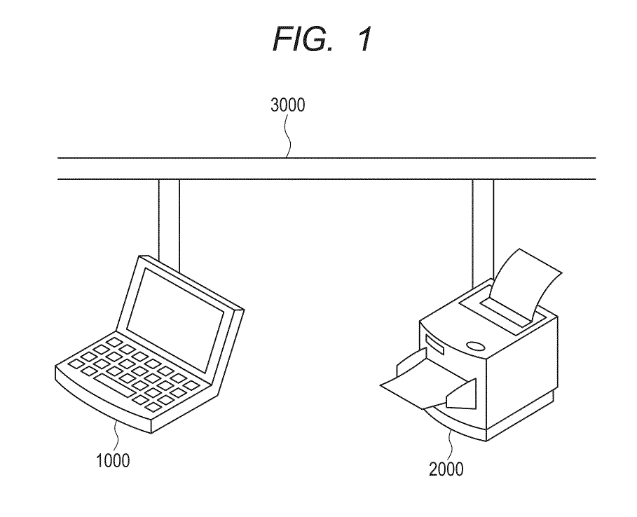

FIG. 1 is a diagram illustrating an example of a whole construction of a print system. At least a host computer 1000 and a printer 2000 are included in the print system. In the example illustrated in FIG. 1, a case where the host computer 1000 and the printer 2000 are connected so that they can communicate with each other through a network 3000 such as LAN, WAN, or the like is shown as an example. However, a connecting form of the host computer 1000 and the printer 2000 is not limited to such an example but may be a local connection. The print system including the host computer 1000 and the printer 2000 may be a system comprising a single apparatus or a plurality of apparatuses so long as the functions of the invention are executed.

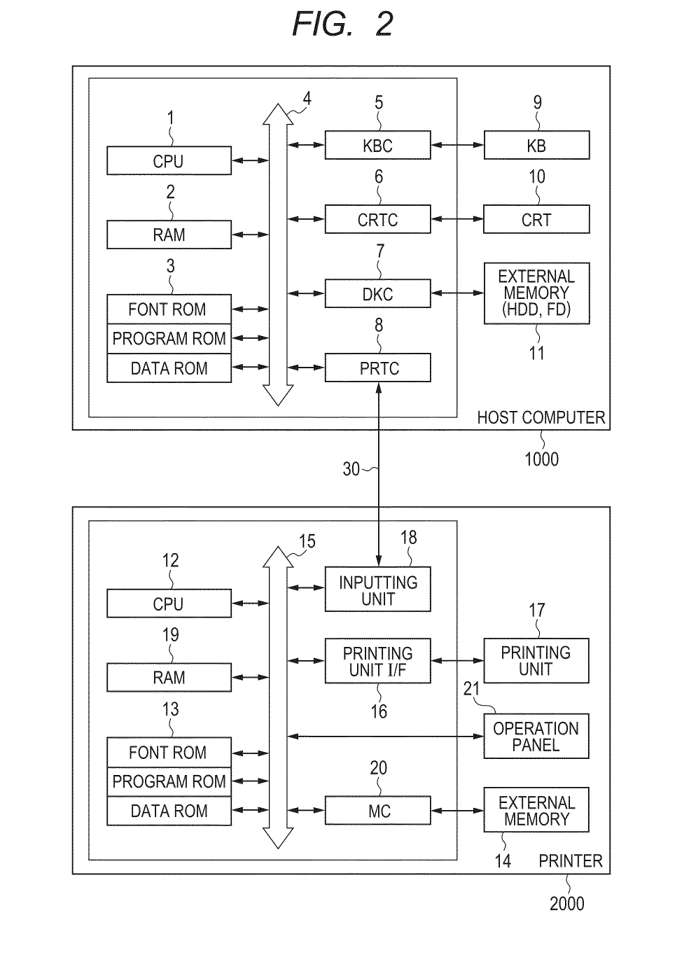

FIG. 2 is a diagram illustrating an example of a construction of hardware of the host computer 1000 and the printer 2000.

In FIG. 2, the host computer 1000 has a CPU 1 for processing a document or an image on the basis of a document processing program or the like stored in a program ROM in a ROM 3 or an external memory 11. The CPU 1 integratedly controls each printer 2000 connected to a system bus 4.

An operating system or the like serving as a control program of the CPU 1 is stored in the program ROM in the ROM 3 or the external memory 11. Font data or the like which is used when the document is processed is stored in a font ROM in the ROM 3 or the external memory 11. Various kinds of data which is used when a process or the like of the document or image is executed is stored in a data ROM in the ROM 3 or the external memory 11. A RAM 2 functions as a main memory, a work area, or the like of the CPU 1.

A keyboard controller (KBC) 5 controls a key input from a keyboard 9 or a pointing device (not shown). A CRT controller (CRTC) 6 controls a display of a CRT display (CRT) 10. A disk controller (DKC) 7 controls an access to the external memory 11 such as a hard disk (HDD) or the like in which a boot program, various kinds of applications, font data, a printer driver, and the like have been stored. A printer controller (PRTC) 8 is connected to the printer 2000 through a bidirectional interface 30 and executes a communication control process of communication with the printer 2000.

The CPU 1 executes a developing (rasterizing) process of an outline font to a display information RAM set on the RAM 2, thereby enabling WYSIWYG on the CRT 10. The CPU 1 also opens various kinds of registered windows on the basis of commands instructed by a mouse cursor or the like (not shown) on the CRT 10 and executes various kinds of data processes. When executing the printing, the user opens the window regarding a setting of the printing and can make a setting of the printer and a setting of a print processing method to the printer driver including a selection of a printing mode.

The printer 2000 is controlled by a CPU 12. The CPU 12 operates on the basis of a control program or the like stored in a program ROM in a ROM 13 or an external memory 14. The CPU 12 outputs an image signal serving as output information to a printing unit (printer engine) 17 connected to a system bus 15 through a printing unit I/F 16. The control program or the like of the CPU 12 is stored in the program ROM in the ROM 13. Font data or the like which is used when the foregoing output information is generated is stored in a font ROM in the ROM 13. If the printer 2000 is a printer without the external memory 14 such as a hard disk or the like, information or the like which is used in the host computer 1000 is stored in a data ROM in the ROM 13.

The CPU 12 can execute a communicating process with the host computer 1000 through an inputting unit 18 and can notify the host computer 1000 of information or the like in the printer 2000. The inputting unit 18 has switches which are used for the user to operate an operation panel 21, an LED display, and the like.

A RAM 19 functions as a main memory, a work area, or the like of the CPU 12. The RAM 19 is also used as a rasterizing area of the foregoing output information, a storing area of environment data, or the like.

The external memory 14 is connected as an option to the printer 2000. Font data, an emulation program, form data, a program to interpret a printer control language of a different language system, print mode setting information which was input from the operation panel 21, and the like have been stored in the external memory 14. An access to the external memory 14 is controlled by a memory controller (MC) 20. The external memory 14 is not limited to one memory but a plurality of external memories may be used.

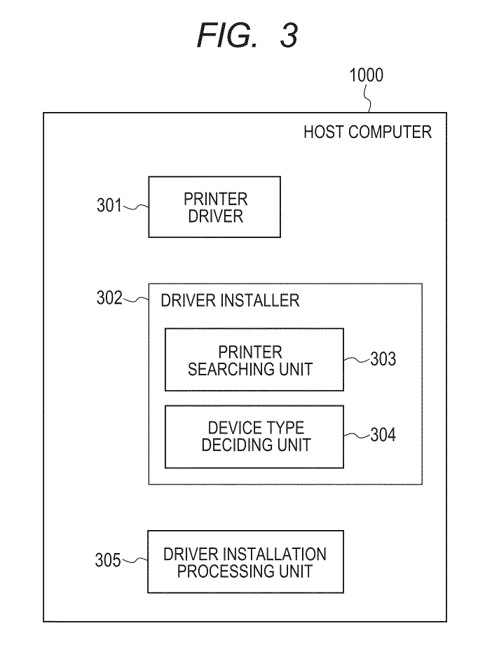

FIG. 3 is a diagram illustrating an example of a construction of software of the host computer 1000.

A printer driver 301 is installed in the host computer 1000 by a driver installer 302. The printer driver 301 is a universal printer driver to control a plurality of kinds of printers having different functions. As mentioned above, it is assumed that the printer driver 301 can change all capabilities including the specific capability by the configuration settings instead of including the function of each model, into a database. Details of the configuration settings will be described hereinafter.

The driver installer 302 is an application program and has a printer searching unit 303 and a device type deciding unit 304. The printer searching unit 303 searches for the printer 2000 connected to the host computer 1000 so that it can communicate therewith. The printer searching unit 303 obtains configuration information of the printer from the printer 2000 which was found as a result of the search. The configuration information of the printer includes, for example, a printer name and a basic capability of the printer of the printer name. Naturally, other information may be included. Details of a process of the device type deciding unit 304 will be described hereinafter.

A driver installation processing unit 305 executes an installing process of the printer driver 301 by an instruction from the driver installer 302.

Subsequently, an example of a processing method for uniquely constructing a printing setting screen by the configuration settings even if the printer driver 301 does not have the function of each model as a database will be described. Before executing the process by using the configuration setting screen, the user selects a printer serving as a setting target of the configuration setting information by using a selecting display screen which is provided by the operating system.

FIGS. 4A to 4D are diagrams illustrating an example of a configuration setting screen 400. Specifically speaking, FIGS. 4A, 4B, 4C, and 4D are the diagrams illustrating the configuration setting screens 400 in the case where “STANDARD”, “STANDARD (Max)”, “MFP-xxx Series”, and “SFP-xxx Series” are selected as device types, respectively. MFP is Multi Function Printer and SFP is Single Function Printer.

In FIGS. 4A to 4D, a pull-down menu 401 to select a device type is a control to convert the configuration settings in a batch manner.

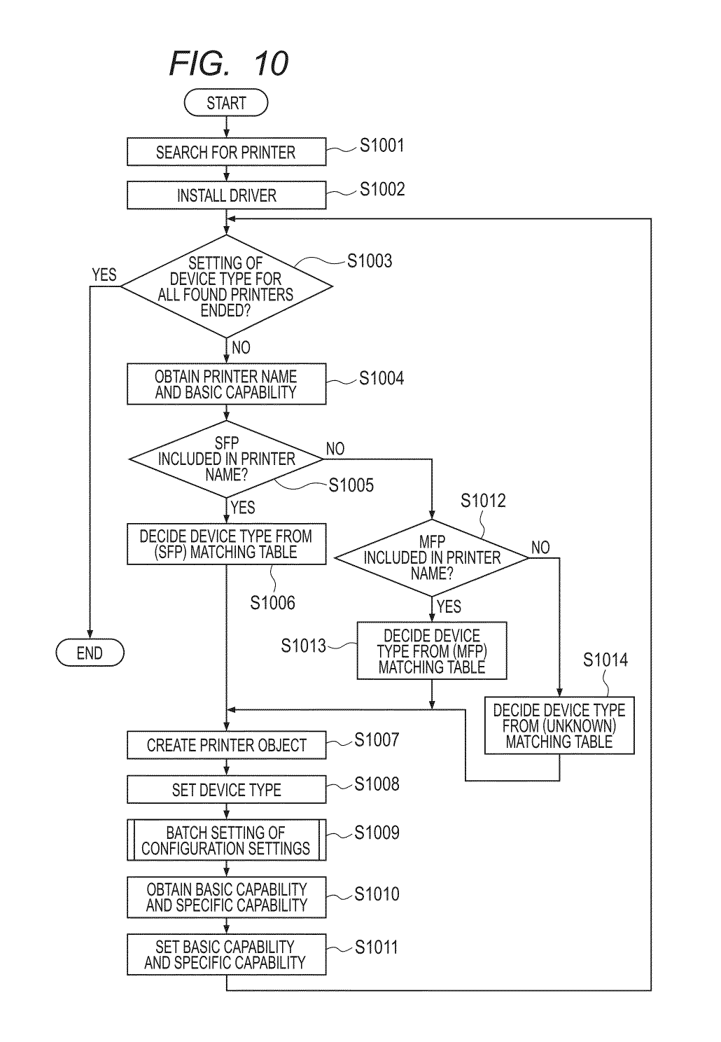

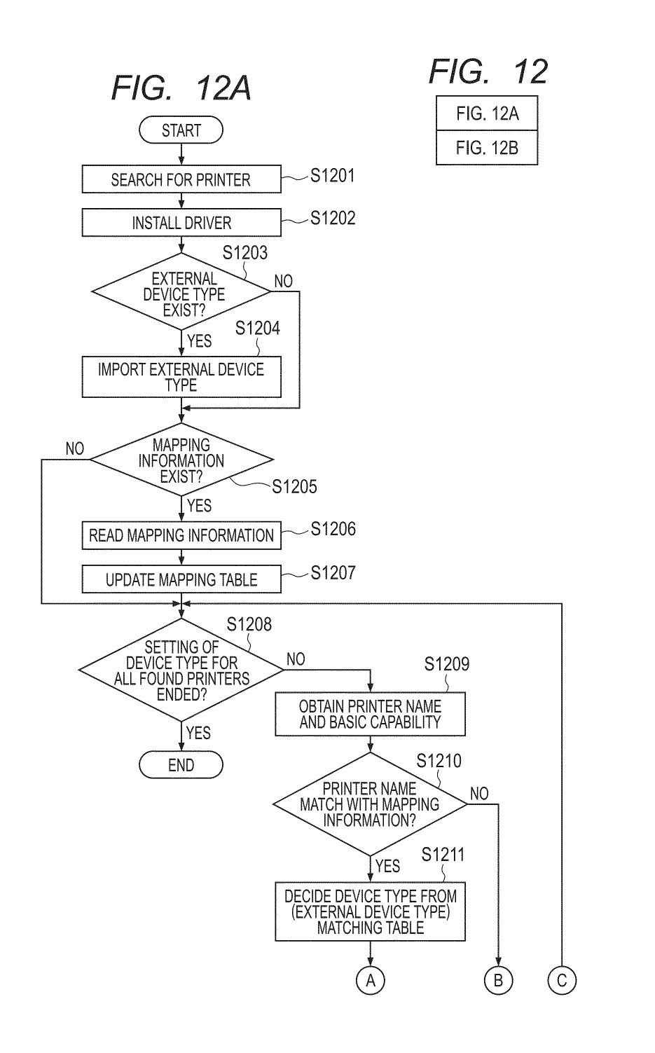

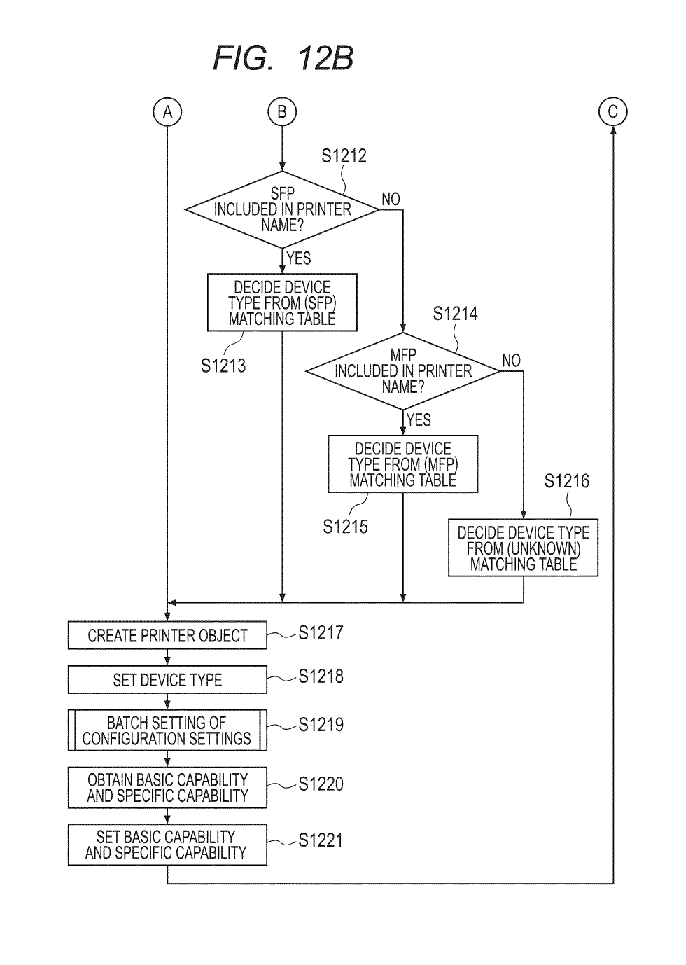

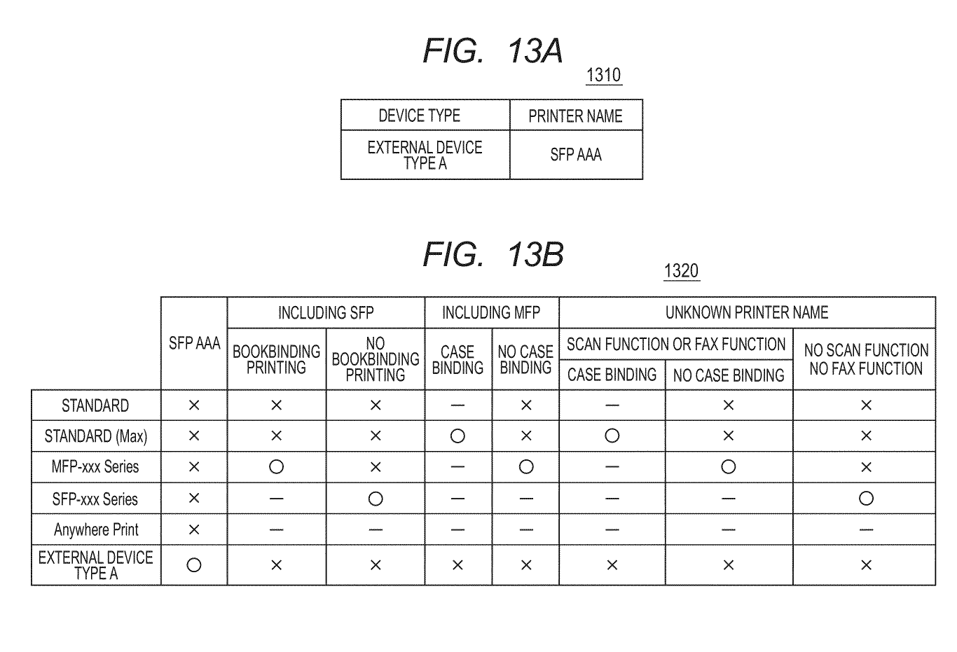

The device type selecting pull-down menu 401 is used, for example, in the case where after completion of a process according to flowcharts of FIGS. 10 and 12 (after the printer driver 301 was installed), configuration settings to a new printer 2000 are made in a batch manner. That is, the user selects the device type corresponding to the new printer 2000 from the device type selecting pull-down menu 401. Thus, setting information of the device type selected by the device type selecting pull-down menu 401 is applied as configuration settings to the printer 2000 in a batch manner. In this case, the setting information of the device type selected by the device type selecting pull-down menu 401 is listed under the device type selecting pull-down menu 401. The detailed contents of the setting information of the device type will be described hereinafter with reference to FIG. 7.

An import button 402 of the device type is a button to import the setting information of the device type which is used at the time of a batch-conversion of the configuration settings, which will be described hereinafter.

A basic capability display column 403 is a column to display a basic capability of the device type selected by the device type selecting pull-down menu 401. A pull-down menu 404 to select a device kind is displayed in the basic capability display column 403. Further, a check box 405 to select a stapling, the check box 406 to select the duplex printing, a check box 407 to select a bookbinding printing, and a check box 408 to select a case binding are displayed in the basic capability display column 403.

The device kind selecting pull-down menu 404 is used to select the kind of device. The device kind is specified by, for example, information in which information showing whether the device is an A3-type device or an A4-type device (that is, whether a maximum paper size to be supported is equal to A3 or A4) and information showing whether the device is a color device or a monochromatic device are combined. In the example illustrated in FIG. 4A, since “STANDARD” has been selected as a device type, a fact that the kind of device whose device type is standard is the A4-type device and the monochromatic device has been selected by the device kind selecting pull-down menu 404.

The stapling selecting check box 405, duplex printing selecting check box 406, bookbinding printing selecting check box 407, and case binding selecting check box 408 have the following roles. That is, they have a role showing whether or not each function is available upon printing and a role to designate whether or not the available function is used.

Among them, the device type which is not available among the device types selected by the device type selecting pull-down menu 401 is displayed in a gray color and the selection about whether or not it is used cannot be performed. The device type which is available among the device types selected by the device type selecting pull-down menu 401 (which is not displayed in a gray color) can be used by checking the check box. In the example illustrated in FIG. 4A, “STANDARD” has been selected as a device type. All basic capabilities of stapling, duplex printing, bookbinding printing, and case binding can be used. In FIG. 4A, since the check boxes 405 to 408 are not checked, such a setting that all of the basic capabilities of them are not used has been made.

A specific capability display column 409 is a column to display the specific capability. A pull-down menu 410 to select a processing method of a paper kind and a button 411 for an advanced setting of a processing capability of a paper size are displayed in the specific capability display column 409.

The processing method of the paper kind shows a method of the process in the main body of the printer 2000 according to the paper kind (plain paper, thick paper, OHP, or the like) selected as paper to be used for printing. In the pull-down menu 410 to select the processing method of the paper kind, any one of <none>, <select paper feeding stage>, and <set fixing temperature> can be selected.

When <select paper feeding stage> is selected, a print job (command) for allowing the printer 2000 to select the paper feeding stage in which the paper of the paper kind selected as a kind of paper to be used for printing is generated. When <set fixing temperature> is selected, a print job (command) for allowing the printer 2000 to operate in the fixing mode according to the paper kind selected as paper to be used for printing. When <none> is selected, the selecting instruction of the paper feeding stage and the operating instruction of the fixing mode according to the paper kind are not performed.

In the example illustrated in FIG. 4A, in the device whose device type is standard, such a setting that the instruction to select the paper feeding stage according to the paper kind and the instruction to operate in the fixing mode according to the paper kind are not performed has been selected.

The processing capability of the paper size has information to control: the paper size which is supported by the printer 2000; and availability of the duplex printing and a stapling-practicable position in each paper size to be supported by the printer 2000.

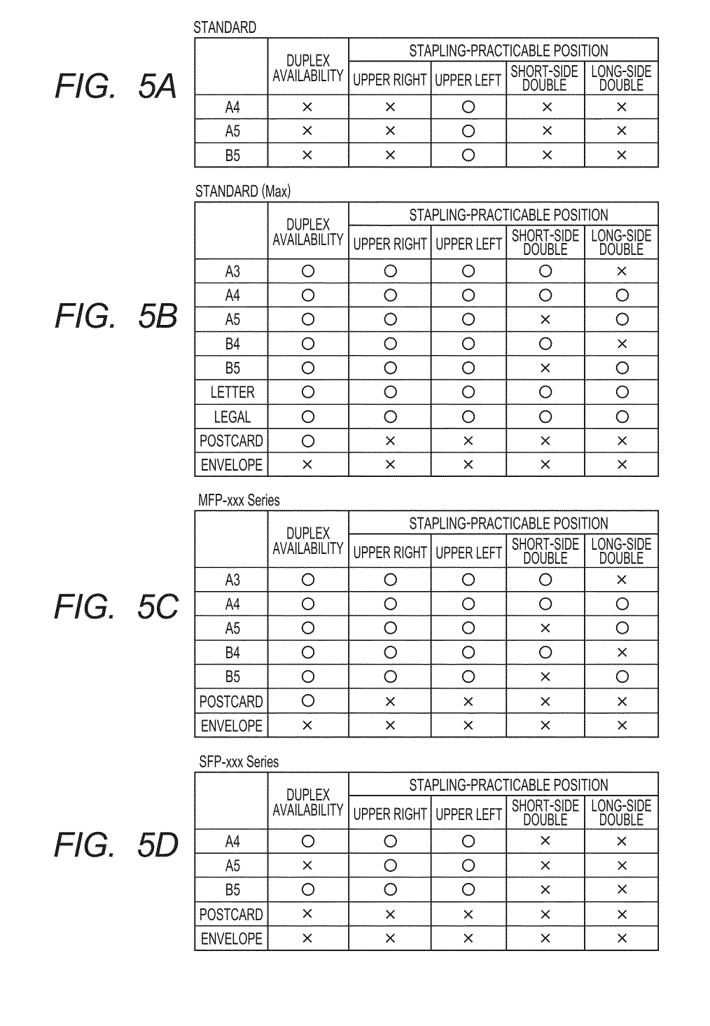

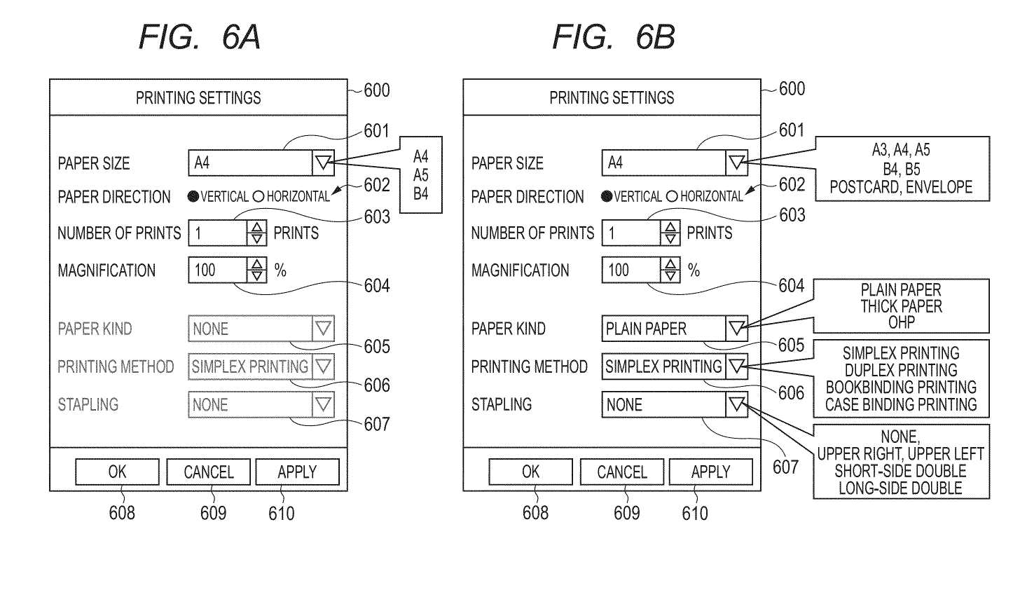

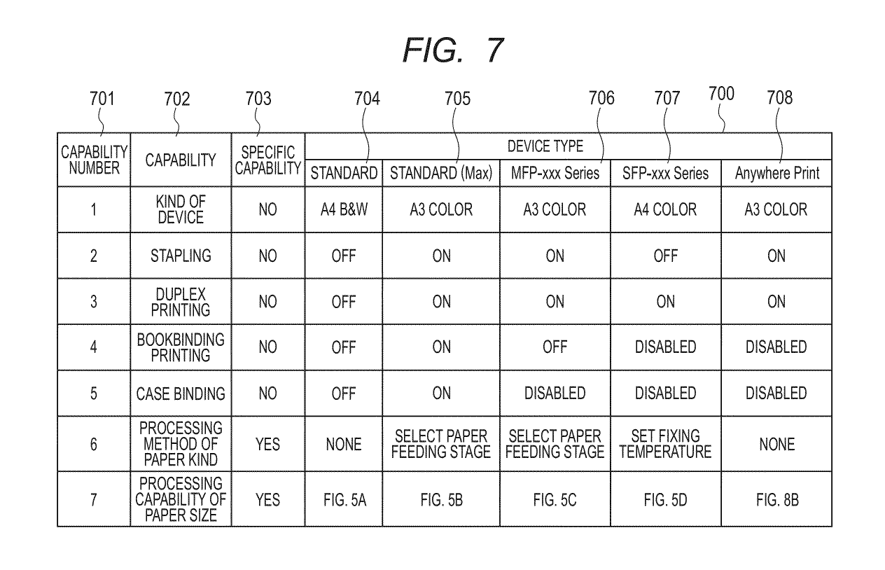

FIGS. 5A to 5D are diagrams illustrating an example of the processing capability of the paper size. Specifically speaking, FIGS. 5A, 5B, 5C, and 5D are the diagrams illustrating the processing capability of the paper size of the printer 2000 in the case where the device types are “STANDARD”, “STANDARD (Max)”, “MFP-xxx Series”, and “SFP-xxx Series” are selected, respectively.

In the example illustrated in FIG. 5A, the printer 2000 whose device type is “STANDARD” supports the paper sizes of <A4>, <A5>, and <B5> and it is shown that in any one of those paper sizes, the duplex printing is impossible (“x”) and the stapling can be performed only at an upper left position of each paper (“∘”). A setting of an increase/decrease of the number of paper sizes to be supported, a setting of the duplex availability of each paper size, and a setting of the stapling-practicable position of each paper size can be edited by pressing the button 411 for the advanced setting of the processing capability of the paper size. That is, when the processing capability advanced setting button 411 of the paper size is depressed, an editing display screen of the processing capability of the paper size in the device type selected by the device type selecting pull-down menu 401 is opened. By operating the editing display screen, the user can edit the processing capability of the paper size.

A button 412 to obtain configuration information is a button to obtain the configuration information (printer name and basic capability) from the printer 2000. As will be described hereinafter, in the embodiment, the device type is decided by the configuration information. Therefore, for example, after completion of processes according to the flowcharts of FIGS. 10 and 12, which will be described hereinafter (after the printer driver 301 was installed), when a device type of a new printer 2000 is set, the configuration information obtaining button 412 is used. An OK button 413, a cancel button 414, and an update button 415 are buttons which are depressed when the setting is decided, the setting is cancelled, and the setting is updated, respectively.

As mentioned above, in the embodiment, a function setting is displayed by the display of the configuration setting screen 400 and the configuration setting screen 400 has a role as a function setting screen to set the function information of the printer 2000.

FIGS. 6A and 6B are diagrams illustrating an example of a printing setting screen 600. Specifically speaking, FIG. 6A illustrates the example of the printing setting screen based on the configuration settings of the contents illustrated in FIG. 4A. FIG. 6B illustrates the example of the printing setting screen based on the configuration settings of the contents illustrated in FIG. 4B. An example of a processing method to construct the printing setting screen on the basis of the contents of the printing setting screen 600 and the configuration settings illustrated in FIG. 4A will be described by using the printing setting screen 600 of FIG. 6A.

A pull-down menu 601 to select a paper size is used to select a paper size upon execution of the printing. In this instance, <A4>, <A5>, and <B5> are listed on the paper size selecting pull-down menu 601 in accordance with list information of the processing capabilities of the paper sizes illustrated in FIG. 5A. A paper direction selecting column 602, a number of prints selecting column 603, and a magnification selecting column 604 are used to select a direction of the paper, the number of prints, and a magnification, respectively. A pull-down menu 605 to select a paper kind is used to select a kind of paper. As illustrated in FIG. 4A, when the device type is standard, “none” has been selected as a processing method of the paper kind. Therefore, in FIG. 6A, the function to select the paper kind is disable-displayed so as to be disabled. “disable-display” denotes that a relevant item is set into a state where it cannot be selected on a UT and the item is displayed in a gray color.

A pull-down menu 606 to select a printing method is used to select a printing method such as <simplex printing>, <duplex printing>, or the like. Choices in the printing method selecting pull-down menu 606 depend on (basic capability of) the configuration settings. The items checked by the duplex printing selecting check box 406, the bookbinding printing selecting check box 407, and the case binding selecting check box 408 in FIGS. 4A to 4D are listed on the printing method selecting pull-down menu 606 in addition to <simplex printing>. In the configuration setting screen 400 illustrated in FIG. 4A, all check boxes are not checked (Off). Therefore, in FIG. 6A, in the printing method selecting pull-down menu 606, <simplex printing> is displayed in a gray color and the apparatus is in a state where other selections are impossible (disable-display). In other words, in the printing method selecting pull-down menu 606, <simplex printing> has fixedly been designated as a printing method.

A pull-down menu 607 to select a stapling is used to select a stapling position. A display of the stapling selecting pull-down menu 607 depends on the configuration settings (device type selecting pull-down menu 401, stapling selecting check box 405). If the stapling selecting check box 405 is checking (is turned On), the stapling selecting pull-down menu 607 is enabled. Specifically speaking, in addition to <none>, the stapling-practicable positions which can be used by the processing capability of the paper sizes illustrated in FIGS. 5A to 5D in accordance with the paper size selected by the paper size selecting pull-down menu 601 are listed on the stapling selecting pull-down menu 607. In the configuration setting screen 400 illustrated in FIG. 4A, the stapling selecting check box 405 is not checked (Off). Therefore, in FIG. 6A, in the stapling selecting pull-down menu 607, <none> is displayed in a gray color and the apparatus is in a state where the selection is impossible (disable-display).

An OK button 608, a cancel button 609, and an update button 610 are buttons which are depressed when the setting is decided, the setting is cancelled, and the setting is updated, respectively.

Subsequently, an example of a processing method for constructing a printing setting screen on the basis of the configuration settings illustrated in FIG. 4B will be described with reference to the printing setting screen 600 in FIG. 6B.

In the example illustrated in FIG. 4B, <A3 color device> has been selected in the device kind selecting pull-down menu 404. All of the stapling selecting check box 405, duplex printing selecting check box 406, bookbinding printing selecting check box 407, and case binding selecting check box 408 have been checked. In the pull-down menu 410 to select the processing method of the paper kind, <select paper feeding stage> has been selected. It is assumed that the processing capability of the paper size edited by the button 411 for the advanced setting of the processing capability of the paper size has the contents of a table illustrated in FIG. 5B.

The printing setting screen 600 illustrated in FIG. 6B is generated on the basis of the configuration settings.

Choices of the paper size selecting pull-down menu 601 are <A3>, <A4>, <A5>, <B4>, <B5>, <postcard>, and <envelope> in accordance with the processing capability of the paper size illustrated in FIG. 5B. In FIG. 4B, in the pull-down menu 410 to select the processing method of the paper kind, <select paper feeding stage> has been selected. Therefore, in the paper kind selecting pull-down menu 605, the paper kind can be selected (valid display). As choices in the paper kind selecting pull-down menu 605, paper kinds such as <plain paper>, <thick paper>, <OHP>, and the like are listed. The paper kind selected here is converted into a command suitable for <select paper feeding stage> selected in the pull-down menu 410 to select the processing method of the paper kind, and a print job is generated. If <set fixing temperature> was selected in the pull-down menu 410 to select the processing method of the paper kind, the paper kind selected in the paper kind selecting pull-down menu 605 is converted into a command to control the fixing mode of the printer 2000.

In FIG. 4B, the duplex printing selecting check box 406, bookbinding printing selecting check box 407, and case binding selecting check box 408 have been checked. In FIG. 6B, <A4> has been selected in the paper size selecting pull-down menu 601. Such a setting that the duplex printing of the paper of “A4” can be performed in the processing capability of the paper size illustrated in FIG. 5B has been made. Consequently, <simplex printing>, <duplex printing>, <bookbinding printing>, and <case binding> are listed on the printing method selecting pull-down menu 606 and any one of them can be selected (valid display).

In FIG. 6B, <A4> has been selected in the paper size selecting pull-down menu 601. Further, from the processing capability of the paper size of (“A4”) illustrated in FIG. 5B, <none>, <upper right>, <upper left>, <short-side double>, and <long-side double> are listed on the stapling selecting pull-down menu 607 and any one of them can be selected (valid display). As mentioned above, in the embodiment, an instruction setting display is performed by the display of the printing setting screen 600 and the printing setting screen 600 has a role as an instruction setting screen for generating a control command to the printer 2000. That is, the control command to be transmitted to the printer is generated on the basis of the printing setting information which was set by the printing setting screen 600.

Processes regarding the configuration setting screen 400 and the printing setting screen 600 mentioned above can be executed by, for example, the printer driver 301.

As mentioned above, the printing setting screen 600 can be uniquely constructed by setting the configuration setting information (a setting about which one of the basic capabilities is used and a setting of the specific capability) by using the configuration setting screen 400. Therefore, the printing setting screen 600 which supports an arbitrary printer 2000 can be provided. In other words, if the capability is properly set by the configuration settings, a suitable printing setting environment can be provided even to a printer 2000 having unknown specifications which will be put on sale in future.

However, it is not always easy for the user to manually set the capability, particularly, the specific capability of each printer 2000. Therefore, in the embodiment, it is constructed in such a manner that the configuration settings can be changed on a device type unit basis in a batch manner.

First, a processing method in the case of changing the configuration settings in a batch manner will be described. In the case where the configuration setting screen 400 is operated and the configuration settings are changed in a batch manner, the device type is changed by the device type selecting pull-down menu 401.

First, setting values at the time of changing the configuration settings in a match manner will be described.

FIG. 7 is a diagram illustrating an example of the setting information of device types.

A capability number 701 is a number to identify each capability. A capability 702 is a name of the capability and corresponds to each capability which is displayed on the configuration setting screen 400 illustrated in FIGS. 4A to 4D.

A specific capability 703 indicates whether or not each capability displayed in the column of the capability 702 is a specific capability. For example, in FIG. 7, since “no” is set in the column of the specific capability 703, it is shown that “kind of device” is not the specific capability. Since “yes” is set in the column of the specific capability 703 of “processing method of paper kind”, it is shown that “processing method of paper kind” is the specific capability.

“STANDARD” 704, “STANDARD (Max)” 705, “MFP-xxx Series” 706, “SFP-xxx Series” 707, and “Anywhere Print” 708 are device types 700, respectively. Those “STANDARD” 704, “STANDARD (Max)” 705, “MFP-xxx Series” 706, “SFP-xxx Series” 707, and “Anywhere Print” 708 are choices which are listed on the device type selecting pull-down menu 401. Setting information which the printer of each device type has is stored in the columns of “STANDARD” 704, “STANDARD (Max)” 705, “MFP-xxx Series” 706, “SFP-xxx Series” 707, and “Anywhere Print” 708, respectively. A maximum capability, a current capability, and a specific capability are included in the setting information.

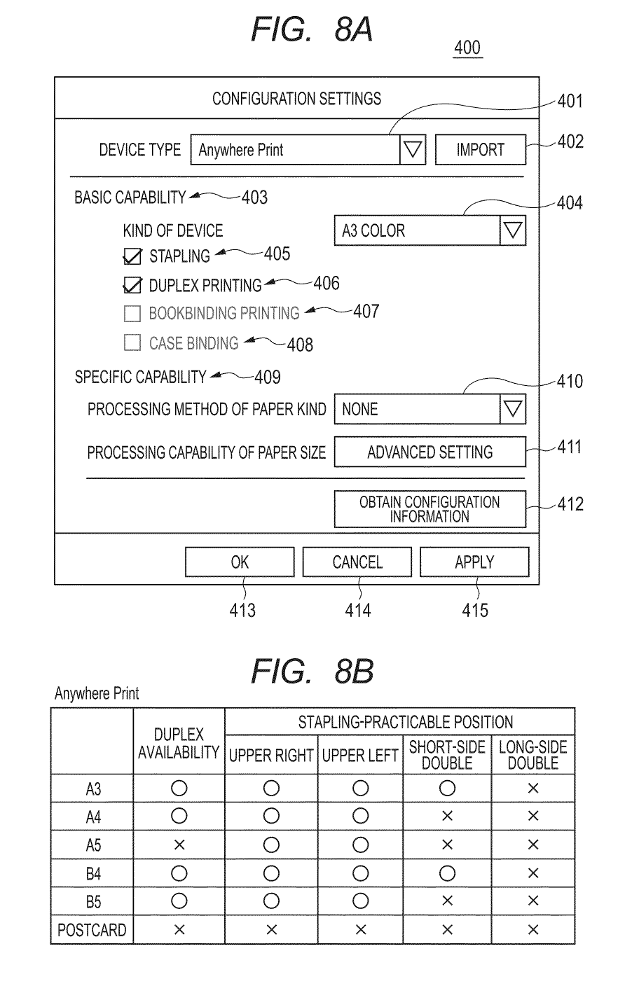

“Anywhere Print” 708 illustrated in FIG. 7 is a device type which can be selected in all printers 2000. FIGS. 8A and 8B illustrate an example of a configuration setting screen (FIG. 8A) of “Anywhere Print” and a processing capability (FIG. 8B) of the paper size. If “Anywhere Print” is selected in “Device Type” 401, the configuration setting screen 400 illustrated in FIG. 8A is obtained in accordance with the setting information of “Anywhere Print” 708 illustrated in FIG. 7. In FIG. 7, the processing capability of the paper size of “Anywhere Print” 708 has the contents illustrated in FIG. 8B.

As mentioned above, according to the embodiment, the setting information of the device illustrated in FIG. 7 has a role as a device configuration type information, the device type has a role as a group, and the information of each column of the setting information of the device illustrated in FIG. 7 has a role as function information.

A reason why the device types are classified into groups by using the printer names such as “MFP-xxx Series”, “SFP-xxx Series”, and the like is as follows. That is, it is because if the existing printers and a printer which will be put on sale in future are printers of the same series, a possibility that their printer names and basic capabilities are identical is high.

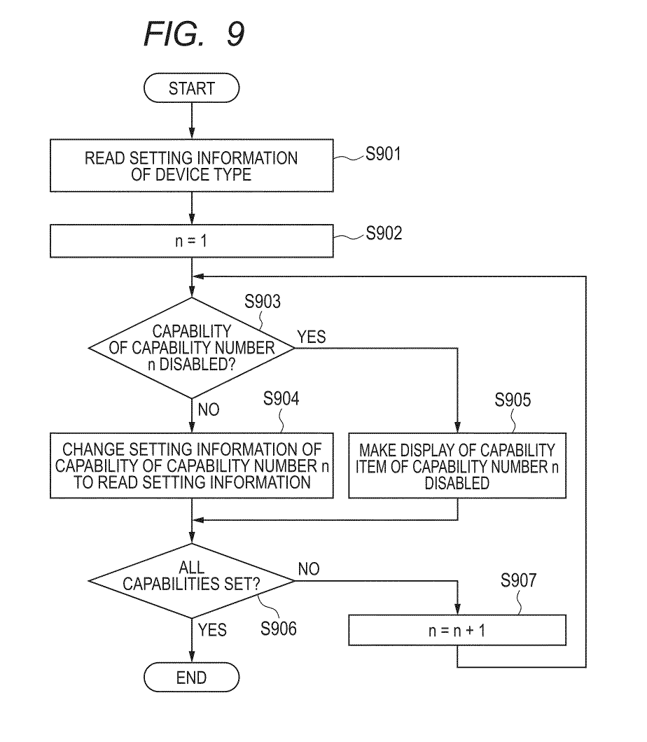

Subsequently, an example of a process which is executed when the configuration settings are changed in a batch-manner will be described with reference to a flowchart of FIG. 9. For example, when the printer driver 301 is installed, the flowchart of FIG. 9 is executed by the driver installer 302. After the printer driver 301 was installed, it is executed by the printer driver 301. In this instance, a description will be made on the assumption that the printer driver 301 executes the flowchart of FIG. 9. In this instance, a description will be made also on the assumption that the setting information stored in the column of “STANDARD” 704 is applied as a default to the configuration setting screen 400 illustrated in FIG. 4A. In this case, when the choices listed on the device type selecting pull-down menu 401 of the configuration setting screen 400 are changed, the process according to the flowchart of FIG. 9 is started.

First, in step S901, the printer driver 301 reads the setting information corresponding to the device type selected by the device type selecting pull-down menu 401 (refer to FIG. 7). It is now assumed that the information of the capability number 701 and the specific capability 703 is also read. As mentioned above, the import of the setting information is executed by depressing the import button 402 of the device type.

Subsequently, in step S902, the printer driver 301 sets “1” into a variable n to refer to the capability number 701 of the setting information which was read in step S901.

Subsequently, in step S903, the printer driver 301 discriminates whether or not the capability of the capability number n should be disabled. For example, the contents of the setting information of the capability of the capability number n are referred to from the setting information of the device type which was read in step S901. If the referred contents indicate <disabled>, it can be decided that the capability of the capability number n should be disabled. If the referred contents indicate contents other than <disabled>, it can be decided that the capability of the capability number n should not be disabled.

As a result of the discrimination, if the capability of the capability number n should not be disabled, step S904 follows. In step S904, the printer driver 301 changes the current contents of the setting information of the capability number n to the contents of the setting information (capability of the capability number n) which was read in step S901. For example, if “STANDARD” is selected as a device type, a setting value of the processing method of the paper kind and a setting value of the processing capability of the paper size are changed to “none” in FIG. 7 and “FIG. 5A”, respectively. The processing routine advances to step S906, which will be described hereinafter.

If the capability of the capability number n should be disabled, step S905 follows. In step S905, the printer driver 301 makes a display of the item corresponding to the capability number n on the configuration setting screen 400 disabled, and advances to step S906.

When the processing routine advances to step S906 in this manner, the printer driver 301 discriminates whether or not all of the setting information (capability numbers 701) which was read in step S901 has been selected. As a result of the discrimination, if all of the capability numbers 701 are not selected, step S907 follows. In step S907, the printer driver 301 adds “1” to the variable n, returns to step S903, and also executes a similar process with respect to the capability of the next capability number n.

If it is decided that all of the capability numbers 701 have been selected, this means that the process for reflecting all of the setting information (capability numbers 701) which was read in step S901 to the configuration settings has been executed. Therefore, the process according to the flowchart of FIG. 9 is finished.

Subsequently, an example of a process in the case where <MFP-xxx Series> is selected in the device type selecting pull-down menu 401 of the configuration setting screen 400 in the state of default in FIG. 4A and the configuration setting screen 400 is changed to a display screen illustrated in FIG. 4C will be described. First, in step S901, the setting information of “MFP-xxx Series” 706 in the setting information in FIG. 7 is read.

With respect to the process of each capability, for example, since “stapling” as a capability of the capability number 2 is not a device type which is disabled, a discrimination result in step S903 is NO. Therefore, in step S904, <on> is set as setting information of “stapling” in the device type selecting pull-down menu of the configuration setting screen 400 in FIG. 4A (the stapling selecting check box 405 is set into a valid display).

Since “case binding” as a capability of the capability number 5 is a device type which is disabled, the discrimination result in step S903 is YES. Therefore, in step S905, the case binding selecting check box 408 in the device type selecting pull-down menu 401 of FIG. 4A is disable-displayed.

“processing method of paper kind” as a capability of the capability number 6 is not a device type which is disabled. Therefore, in step S904, <select paper feeding stage> is set (displayed) on the pull-down menu 410 to select the processing method of the paper kind in the configuration setting screen 400.

With respect to each of other capabilities, a process is similarly executed. Details of “processing capability of paper size” are changed from the contents illustrated in FIG. 5A to the contents illustrated in FIG. 5C. Finally, the configuration settings are completed as illustrated in FIG. 4C.

If <SFP-xxx Series> is selected in the device type selecting pull-down menu 401 of the configuration setting screen 400 in the state of default in FIG. 4A, the setting information of “SFP-xxx Series” 707 in FIG. 7 is read. By executing the process according to the flowchart of FIG. 9 in a manner similar to that mentioned above, the configuration settings illustrated in FIG. 4D are obtained. At this time, details of “processing capability of paper size” are changed to the contents illustrated in FIG. 5D.

Advantages which are obtained by the configuration settings in the embodiment as mentioned above will now be summarized below.

First, all capability information also including differences among fine capabilities of the respective printers is displayed every device type onto the configuration setting screen 400, thereby enabling the contents of the configuration settings to be changed every device type by operating the configuration setting screen 400. Therefore, by making a proper setting as configuration settings, the printing setting screen 600 having arbitrary functions and operation specifications can be constructed every device type. Even to a printer having unknown specifications which will be put on sale in future, by making the printer correspond to any one of the device types, the printer driver 301 can suitably support the printer.

It is not always easy that the user correctly sets the specific capability. Therefore, by selecting the device type corresponding to the printer, the configuration settings including the specific capability are enabled to be changed in a batch manner. Thus, even to the printer having unknown specifications, a setting near the capability of the printer can be easily made. By a depression or the like of the button 411 for the advanced setting of the processing capability of the paper size, it is sufficient to manually change only the difference between the specific capabilities. In other words, even to the printer which will be put on sale in future, the configuration settings can be semi-automatically made and usability can be improved.

As mentioned above, according to the embodiment, the device type can be decided by the printer name and the basic capability. However, the device types which were classified every model, the device types which were generally classified every series and category of each model, the device types which were classified in accordance with a specific use case or scenario, or the like can be provided as device types. That is, it is sufficient that the device types are classified in accordance with a kind of printer.

The setting information of the device type which is read at the time of the batch-conversion of the configuration settings by the selection of the device type has setting values every capability (refer to FIG. 7). Therefore, in the printer equipped with the stapling and the duplex printing function as standard specifications, the stapling and the duplex printing can be also set to ON as initial values. Even in the case of selling the printer with a specific optional construction in a business talk or the like, it is sufficient to prepare device types in which necessary functions have been preset. Therefore, as compared with the case of customizing the printer driver 301 itself, the printing setting screen 600 for supporting the printer can be provided more easily.

“disabled” can be set as a setting value of every capability of the setting information of the device type which is read at the time of the batch-conversion of the configuration settings by the selection of the device type. Therefore, for example, in SFP which is generally a small device, “bookbinding printing” and “case binding” which do not depend on the optional construction are disable-displayed, thereby disabling the settings of those capabilities to be changed on the printing setting screen 600. As mentioned above, by setting the maximum capability in accordance with the printer, the user can be supported so as not to make an erroneous setting, so that usability is improved.

In the embodiment, the case where the device type is changed by the device type selecting pull-down menu 401 of the configuration setting screen 400 has been described as an example. However, it is not always necessary to use such a method. For instance, the device type can be also instructed from an external program by using a public I/F. Thus, even if a UI display screen (configuration setting screen 400) of the configuration settings is not opened, the batch-conversion of the configuration settings of the device type can be performed.

In the embodiment, the printer driver 301 has the import function of the device type. As mentioned above, such a function can be realized by a method whereby, for example, an external file is selected by depressing the import button 402 of the device type and the setting information of the device type which was externally formed is fetched. The imported device types are additionally listed on the device type selecting pull-down menu 401. Therefore, the configuration settings to the new printer can be provided as an external file. To the user who bought the printer equipped with a specific option, by additionally providing the device type suitable for such an option, the user can make the optimum configuration settings merely by fetching and selecting the device types which were externally formed. The printer driver 301 may be provided with an export function (not shown) for outputting the configuration settings set by the configuration setting screen as an external file.

Subsequently, an example of a process which is executed when the printer driver 301 is installed will be described with reference to a flowchart of FIG. 10. When an operation to activate the driver installer 302 is executed, the flowchart of FIG. 10 is started.

First, in step S1001, the printer searching unit 303 searches for the printer 2000 which is directly connected to the host computer 1000 or is connected thereto via the network 3000. In this instance, a process for making the printer driver 301 function as a universal printer driver to the printer 2000 which was searched for in step S1001 is executed.

Subsequently, in step S1002, the driver installation processing unit 305 executes a process such as a creation of a printer object or the like in the installing process of the printer driver, that is, executes a process other than processes in step S1003 and subsequent steps. The printer object is displayed, for example, in an item of a printer name of a printing dialog which is displayed when the printing has been selected in a file menu of an application.

Subsequently, the setting of the device type and the batch-setting of the configuration settings are made every printer 2000 which was searched for in step S1001.

First, in step S1003, the driver installer 302 discriminates whether or not the setting of the device types to all of the printers 2000 which were found by the search in step S1001 has been finished. As a result of the discrimination, if the setting of the device types to all of the printers 2000 has been finished, the process according to the flowchart of FIG. 10 is finished.

On the other hand, if the setting of the device types to all of the printers 2000 is not finished, processes in steps S1004 to S1014 are repeated until it is finished.

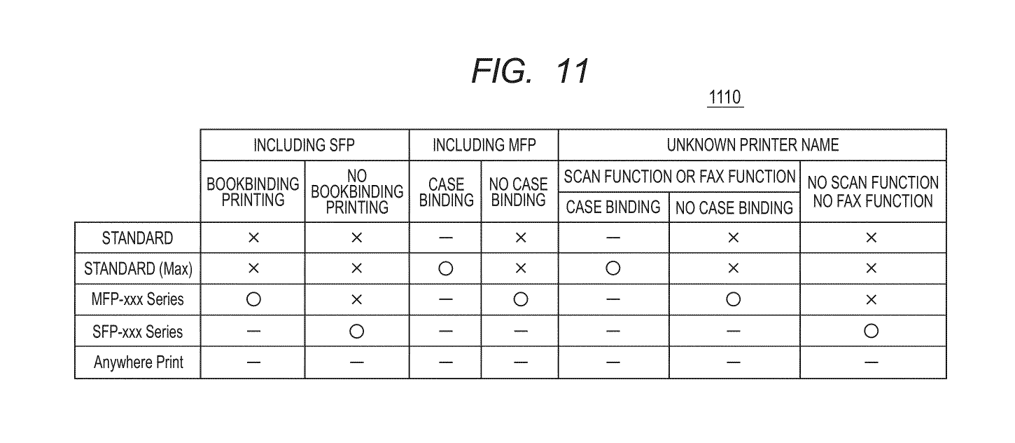

First, in step S1004, the driver installer 302 selects one printer 2000 in which the device type is not set from all of the printers 2000 found by the search in step S1001. The driver installer 302 obtains the printer name and a part of the basic capability of the selected printer 2000. A part of the basic capability is a basic capability necessary for discrimination of the device type, which will be described hereinlater, and is, for example, the bookbinding printing, case binding, Scan function, and Fax function listed on a matching table 1110 illustrated in FIG. 11. The basic capability can be obtained from the printer 2000 which is directly connected to the host computer 1000 or is connected thereto via the network 3000.

Subsequently, in step S1005, the driver installer 302 discriminates whether or not “SFP” is included in the printer name obtained in step S1004. As a result of the discrimination, if “SFP” is not included in the printer name, the processing routine advances to step S1012, which will be described hereinafter. If “SFP” is included in the printer name, step S1006 follows.

In step S1006, on the basis of the printer name and the basic capability obtained in step S1004, the device type deciding unit 304 discriminates the device type of the printer 2000 selected in step S1004. In the embodiment, on the basis of the printer name and the basic capability obtained in step S1004 and the matching table 1110 illustrated in FIG. 11, the proper device type of the printer 2000 selected in step S1004 is decided (that is, the process of step S1006 is executed).

As illustrated in FIG. 11, the matching table 1110 is information to decide a selectable device type (“-”), an unselectable device type (“x”), and a device type (“o”) of the initial setting from the printer name and the basic capability.

An example of the process for deciding the proper device type in step S1006 will be described. For example, it is assumed that information of “no bookbinding printing” can be obtained as a basic capability in step S1004. In this case, the device type deciding unit 304 determines that the initial setting of the device type is <SFP-xxx Series> from the matching table 1110. The device type deciding unit 304 determines that <Anywhere Print> can be selected and other device types cannot be selected. As mentioned above, it is decided that the selection of the device types other than <SFP-xxx Series> and <Anywhere Print> is not permitted. A reason why such a judgment is made is that by narrowing down the capability, the printer driver 301 is controlled so as not to instruct the operation of the capability which the relevant printer 2000 does not hold.

Returning to the description of FIG. 10, when the device type is decided in step S1006, in step S1007, the driver installer 302 creates a printer object of the printer 2000 selected in step S1004.

Subsequently, in step S1008, the driver installer 302 sets the device type to the printer object created in step S1007. At this time, the setting according to the device types decided in steps S1006, S1013, and S1014 is made. In the foregoing example, the driver installer 302 sets <SFP-xxx Series> as an initial setting. The driver installer 302 also sets in such a manner that <Anywhere Print> can be selected in the device type selecting pull-down menu 401 of the configuration setting screen 400. The driver installer 302 also sets in such a manner that the device types other than <SFP-xxx Series> and <Anywhere Print> cannot be selected in the device type selecting pull-down menu 401 of the configuration setting screen 400.

Subsequently, in step S1009, the driver installer 302 performs the batch-setting of the configuration settings. In the batch-setting of the configuration settings, a process similar to that of the flowchart of FIG. 9 mentioned above is executed. At this time, in step S901 in FIG. 9, the setting information of the device types decided in steps S1006, S1013, and S1014 is read. In this instance, the configuration setting screen 400 is not displayed.

In step S1010, the driver installer 302 obtains the basic capability and the specific capability of the printer 2000 selected in step S1004. Those capabilities can be obtained from the printer 2000 which is directly connected to the host computer 1000 or is connected thereto via the network 3000. However, a specific capability which cannot be obtained also exists among the specific capabilities. Although a part of the basic capability of the printer 2000 is obtained in step S1004, all of the basic capabilities of the printer 2000 are obtained in step S1013. As for the basic capability of the printer 2000, the information obtained in step S1004 may be held in a holding unit and the basic capability may be obtained from the holding unit.

Subsequently, in step S1011, the driver installer 302 sets the basic capability and the specific capability obtained in step S1010 into the configuration settings of the printer 2000 selected in step S1004. That is, the configuration settings about the printer 2000 selected in step S1004 are not the configuration settings which were batch-set in step S1009 but the configuration settings which were set in step S1011. At this time, with respect to the capability which could not be obtained in step S1011, the contents of the configuration settings which were batch-set in step S1009 are set to the configuration settings of the printer 2000 selected in step S1004. With respect to the capability disabled by the batch-setting of the configuration settings in step S1009, it is assumed that even the capability which could be obtained is not applied to the configuration settings of the printer 2000 selected in step S1004.

As mentioned above, by the batch-setting of the configuration settings and the setting of the capability which could be obtained in step S1010, the setting of the configuration settings suitable for the printer 2000 which is directly connected to the host computer 1000 or is connected thereto via the network 3000 can be made.

After completion of the process of the flowchart of FIG. 10, when the configuration setting screen 400 is displayed on the basis of the operation by the user, the contents of the setting in step S1009 are reflected to the configuration setting screen 400 and displayed. After the process of step S1011 was finished in this manner, the processing routine is returned to step S1003 mentioned above. Thus, <SFP-xxx Series> is selected as an initial value onto the device type selecting pull-down menu 401 of the configuration setting screen of the printer driver which was installed by the foregoing example. As other selectable choices, “Anywhere Print” is displayed. Naturally, a choice of the device type which is selected by the device type selecting pull-down menu 401 can be also added by the foregoing operation.

As mentioned above, if “SFP” is not included in the printer name in step S1005, step S1012 follows.

In step S1012, the driver installer 302 discriminates whether or not “MFP” is included in the printer name obtained in step S1004. As a result of the discrimination, if “MFP” is not included in the printer name, the processing routine advances to step S1014, which will be described hereinafter. If “MFP” is included in the printer name, step S1013 follows.

In step S1013, on the basis of the printer name and the basic capability obtained in step S1004, the device type deciding unit 304 decides the device type of the printer 2000 selected in step S1004. For example, it is assumed that information of “case binding” could be obtained as a basic capability in step S1004. In this case, from the matching table 1110, the device type deciding unit 304 decides that the initial setting of the device type is <standard (Max)>. Since “-” has been set in the device types other than <standard (Max)>, the device type deciding unit 304 decides that other device types can be also selected. The foregoing processes of steps S1007 to S1011 are executed. Thus, <standard (Max)> is selected as an initial value onto the device type selecting pull-down menu 401 of the configuration setting screen of the printer driver which was installed by the foregoing example. As other selectable choices, “STANDARD”, “SFP-xxx Series”, “MFP-xxx Series”, and “Anywhere Print” are displayed on the device type selecting pull-down menu 401.

As mentioned above, if it is decided that “MFP” is not included in the printer name in step S1012, step S1014 follows. In step S1014, on the basis of the printer name and the basic capability obtained in step S1004, the device type deciding unit 304 decides the device type of the printer 2000 selected in step S1004. For example, it is assumed that information of “FAX function” and “no case binding” could be obtained as basic capabilities in step S1004. In this case, the device type deciding unit 304 decides from the matching table 1110 that the initial value of the device type is “MFP-xxx Series”. The device type deciding unit 304 also decides that “SFP-xxx Series” and “Anywhere Print” can be selected and that <standard> and <standard (Max)> cannot be selected. The foregoing processes of steps S1007 to S1011 are executed.

In the embodiment, the device type is decided by using the printer name and the basic capability. A reason why the device type is decided by using a part of the printer name in step S1005 or S1012 is that if the existing printers and a printer which will be put on sale in future are printers of the same series, a possibility that parts of the printer names are identical is high.

As mentioned above, in the embodiment, the matching table 1110 in which the contents of the printer name and the basic capability and the device type of the initial setting are stored so as to be associated with each other is preliminarily held. Setting information of every plurality of capabilities is preliminarily held with respect to each of a plurality of device types. Setting information of the capabilities other than the specific capability is information about whether or not each capability is valid or disable and about whether or not the valid capability is used. The setting information of the specific capability is information showing the contents of the capability. The printer name and the basic capability are obtained from the printer 2000 which was searched for at the time of installing the printer driver 301, and the device type of the printer 2000 is decided from the obtained printer name and basic capability and the matching table 1110. The setting information of the decided device type is reflected to the configuration settings and the printing setting screen 600 based on the configuration settings is provided. Therefore, the setting of the optimum device type is automatically made at the time of installing the printer driver 301. Prior to using the printer driver 301, the proper configuration settings according to the device type can be made. Consequently, the proper printing setting screen 600 according to the device type can be provided. As mentioned above, in the embodiment, the universal printer driver which can support the capabilities (functions) of the printer 2000 having unknown specifications as much as possible can be realized.

### Second Embodiment

Subsequently, a second embodiment will be described. In the embodiment, when the printer driver 301 is installed by using the import function to fetch the setting information of the device type which was externally created, the import and the setting of the setting information of the device type which was externally created are performed. As mentioned above, in the embodiment, the construction and process for importing and setting the setting information of the device type which was externally created when the printer driver 301 is installed are added to the first embodiment. Therefore, in the description of the embodiment, substantially the same portions as those in the first embodiment are designated by the same reference numerals as those in FIGS. 1 to 11 and their detailed description is omitted.

An example of the process at the time of installing the printer driver 301 will now be described with reference to a flowchart of FIG. 12. When the operation to activate the driver installer 302 is executed, the process of the flowchart of FIG. 12 is started.

First, in step S1201, in a manner similar to step S1001, the printer searching unit 303 searches for the printer 2000 connected to the host computer 1000 so that it can communicate therewith.

Subsequently, in step S1202, in a manner similar to step S1002, the driver installation processing unit 305 executes a process such as a creation of a printer object or the like in the installing process of the printer driver, that is, executes a process other than processes in step S1203 and subsequent steps.

Subsequently, in step S1203, the driver installer 302 discriminates whether or not an external device type exists in the driver installer 302. Such a discrimination can be performed by, for example, checking whether or not a file of a specific extension existing in a specific folder of the driver installer 302 can be read as an external device type file. As a result of the discrimination, if it is determined that the external device type does not exist, a process of step S1204 is omitted and the processing routine advances to step S1205, which will be described hereinafter.

If it is determined that the external device type exists, the processing routine advances to step S1204. In step S1204, the driver installer 302 imports information in the external device type file into the printer driver 301 which has already been installed by the installing process of step S1202. Thus, the setting information (refer to FIG. 7) of the external device type is added and the information (refer to FIGS. 5A to 5D) of a processing capability of the paper size of the external device type is added. Then, step S1205 follows.

In step S1205, the driver installer 302 discriminates whether or not mapping information of the external device type exists. In a manner similar to the discrimination about the external device type in step S1203, such a discrimination can be performed by checking whether or not a file in which the mapping information is disclosed exists in a specific folder of the driver installer 302. FIG. 13A is a diagram illustrating an example of the mapping information of the external device type. Mapping information 1310 is information showing the device type and the printer name. In the example of the mapping information 1310 illustrated in FIG. 13A, it is shown that the device type <external device type A> has been mapped to the printer name <SFP AAA>. In this instance, if the external device type exists, a description will be made on the assumption that mapping information of such an external device type also exists.

Returning to the description of FIG. 12, in step S1205, if it is decided that the mapping information of the external device type does not exist, processes of steps S1206 to S1207 are omitted and the processing routine advances to step S1208, which will be described hereinafter.

If it is determined that the mapping information of the external device type exists, the processing routine advances to step S1206. In step S1206, the driver installer 302 reads the mapping information 1310.

Subsequently, in step S1207, the driver installer 302 updates the matching table 1110 held in the device type deciding unit 304 from the mapping information 1310 which was read in step S1206. FIG. 13B is a diagram illustrating a matching table 1320 obtained by updating the matching table 1110 illustrated in FIG. 11 on the basis of the mapping information 1310 illustrated in FIG. 13A.

Subsequently, the setting of the device type and the batch-setting of the configuration settings are performed every printer 2000 which was searched for in step S1201.

First, in step S1208, the driver installer 302 discriminates whether or not the setting of the device types to all of the printers 2000 which were found by the search in step S1201 has been finished. As a result of the discrimination, if the setting of the device types to all of the printers 2000 has been finished, the process according to the flowchart of FIG. 12 is finished. On the other hand, if the setting of the device types to all of the printers 2000 is not finished, processes in steps S1209 to S1221 are repeated until it is finished.

First, in step S1209, in a manner similar to step S1004, the driver installer 302 selects one printer 2000 in which the setting of the device type is not made, and obtains the printer name and a part of the basic capability of the selected printer 2000.

Subsequently, in step S1210, the driver installer 302 discriminates whether or not the printer name obtained in step S1209 matches with the printer name of the mapping information 1310. For example, if the mapping information 1310 illustrated in FIG. 13A was read, the driver installer 302 discriminates whether or not the printer name obtained in step S1209 matches with “SFP AAA”.

As a result of the discrimination, if the printer name obtained in step S1209 does not match with the printer name of the mapping information 1310, step S1212 follows. Processes in steps S1212 to S1216 are substantially the same as the processes in steps S1005, S1006, and S1012 to S1014 in FIG. 10 except that a matching table to be referred to is the matching table 1320 illustrated in FIG. 13B. The processing routine advances to step S1217, which will be described hereinafter.

On the other hand, as a result of the discrimination of step S1210, if the printer name obtained in step S1209 matches with the printer name of the mapping information 1310, step S1211 follows. In step S1211, on the basis of the printer name and the basic capability obtained in step S1209, the device type deciding unit 304 discriminates the device type of the printer 2000 selected in step S1209. In this instance, the device type deciding unit 304 discriminates the device type corresponding to the printer name and the basic capability obtained in step S1209 from the updated matching table 1320 illustrated in FIG. 13B. In step S1210, since it is determined that the printer name matches with the mapping information, the device type deciding unit 304 determines that the initial setting of the device type is <external device type A>. The device type deciding unit 304 also determines that other device types cannot be selected.

Subsequently, in step S1217, the driver installer 302 creates a printer object of the printer 2000 selected in step S1209.

Subsequently, in step S1218, the driver installer 302 sets the device type to the printer object created in step S1217. At this time, the setting according to the device type decided in steps S1211, S1213, S1215, and S1216 is made. In the foregoing example, the driver installer 302 sets <external device type A> as an initial setting. In the device type selecting pull-down menu 401 of the configuration setting screen 400, the driver installer 302 sets the device type in such a manner that other device types cannot be selected.

Subsequently, in step S1219, the driver installer 302 performs the batch-setting of the configuration settings. With respect to the batch-setting of the configuration settings, the process is executed in a manner similar to the process of the flowchart of FIG. 9 mentioned above. In step S901 in FIG. 9, the setting information of the device types decided in steps S1211, S1213, S1215, and S1216 is read.

In step S1220, the driver installer 302 obtains the basic capability and the specific capability of the printer 2000 selected in step S1209. Those capabilities can be obtained from the printer 2000 which is directly connected to the host computer 1000 or is connected thereto via the network 3000. However, among the specific capabilities, the specific capability which cannot be obtained also exists. Although a part of the basic capability of the printer 2000 is obtained in step S1209, all of the basic capabilities of the printer 2000 are obtained in step S1220. As for the basic capabilities of the printer 2000, the information obtained in step S1209 may be held in the holding unit and the basic capabilities may be obtained from the holding unit.

Subsequently, in step S1221, the driver installer 302 sets the basic capability and the specific capability which could be obtained in step S1220 into the configuration settings. That is, the configuration settings about the printer 2000 selected in step S1209 are not the configuration settings which were batch-set in step S1219 but the configuration settings which were set in step S1221. At this time, with respect to the capabilities which could not be obtained in step S1220, the contents of the configuration settings which were batch-set in step S1219 are set to the configuration settings of the printer 2000 selected in step S1209. With respect to the capabilities disabled by the batch-setting of the configuration settings in step S1219, it is assumed that even the capabilities which could be obtained are not applied.

As mentioned above, by the batch-setting of the configuration settings and the setting of the capabilities which could be obtained in step S1220, the setting of the configuration settings suitable for the printer 2000 which is directly connected to the host computer 1000 or is connected thereto via the network 3000 can be made.

As mentioned above, in the embodiment, when the printer driver 301 is installed, the setting information of the external device type is imported, the mapping information is read, the matching table is updated, and thereafter, the batch-setting of the configuration settings is made. Therefore, the external device type is set as a device type of the printer 2000 which was searched for, and the configuration settings according to the external device type can be made. Consequently, the number of candidates of the device type can be increased. The setting of the device type which is more suitable to the searched printer 2000 can be executed prior to using the printer driver 301.

In the embodiment, the mapping information 1310 to which the external device type was reflected has been created. However, it is not always necessary to use such a method. For example, the device types which have previously been held in the printer driver 301 can be also set into the mapping information. Thus, the matching table can be flexibly changed in accordance with a use. For example, it is desirable to apply such a method to a case of constructing the matching table so that the same device type is set into all of the printers 2000 in a batch manner, or the like.

In the flowcharts illustrated in FIGS. 10 and 12, when the printer object is created, the printer object name may be changed to a name according to the device type which was decided as an initial setting. By changing in this manner, the printer object is created by the printer object name according to the object of the decided device type or the corresponding model. Therefore, there is such an advantage that when the printing is performed, the printer can be easily selected.

### Third Embodiment

Subsequently, the third embodiment will be described. In the embodiment, such a process that the user selects the decided device on the display screen which is provided by the driver installer 302 and executes the installing process, thereby deciding the initial value of the configuration setting screen will be described. As mentioned above, the embodiment differs from the first and second embodiments mainly with respect to a method of deciding the initial value of the configuration setting screen. Therefore, in the description of the embodiment, substantially the same portions as those in the first and second embodiments are designated by the same reference numerals as those in FIGS. 1 to 13B and their detailed description is omitted.

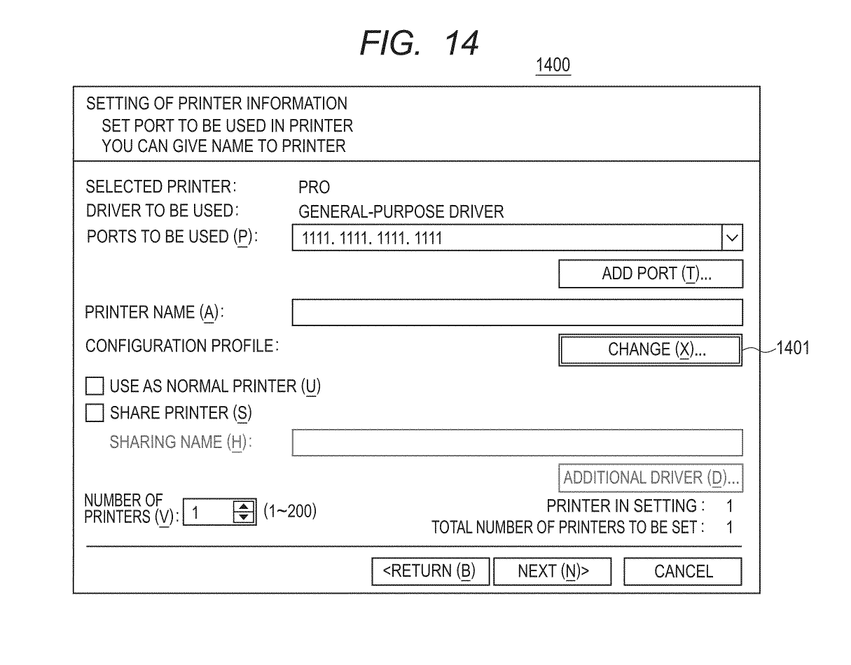

FIG. 14 is a diagram illustrating a display screen which is provided by the driver installer 302. Before a display screen 1400 is displayed, the driver installer 302 displays a list of the printers to which the host computer 1000 can be connected and the printer for printing is selected by an instruction from the user. In the example of FIG. 14, a state where the printer of a name “PRO” has been selected. An IP address of the selected printer is set into a port to be used in the host computer 1000.

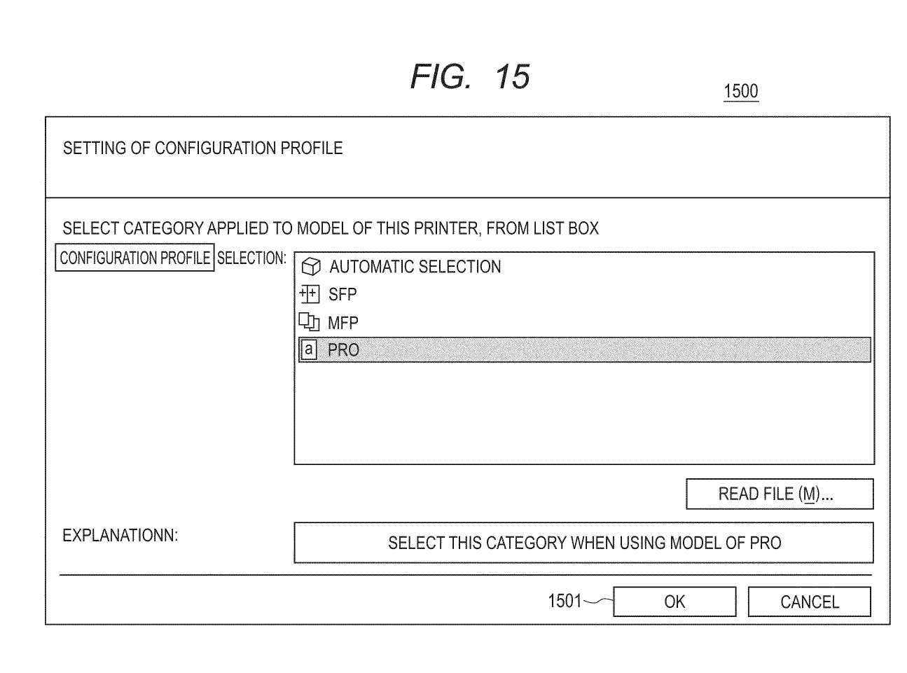

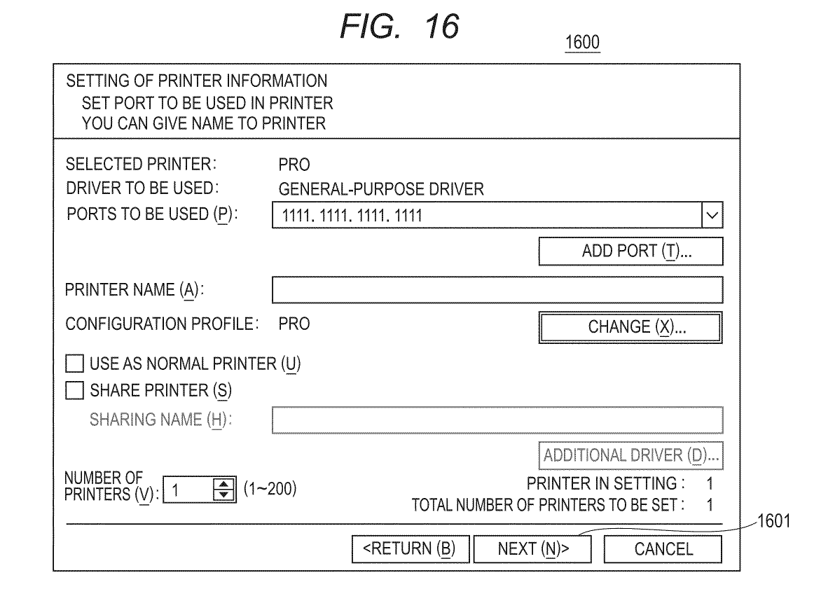

When a change button 1401 of a configuration profile (the same meaning as that of the device type) is depressed, a screen 1500 of FIG. 15 is displayed. Now, the user selects a desired configuration profile and depresses an OK button 1501 (in FIG. 15, it is assumed that PRO has been selected). Thus, a screen 1600 of FIG. 16 is displayed. When a next button 1601 is depressed, the installing process of the printer driver 301 is started. As a first obtaining process, the driver installer 302 stores the configuration profile selected on the screen 1500 illustrated in FIG. 15 into a storage area which the printer driver 301 can refer to. As other information, the driver installer 302 may write, for example, a file path to a file including the configuration profile and a name of the configuration profile to be used as an initial value into the storage area.

The printer driver 301 in which the installing process by the driver installer 302 was finished refers to the storage area and obtains the configuration profile stored by the driver installer 302. The printer driver 301 sets the obtained configuration profile as an initial value. As a second obtaining process, the printer driver 301 obtains the configuration information of the selected printer by using the port set on the display screen of the driver installer 302.

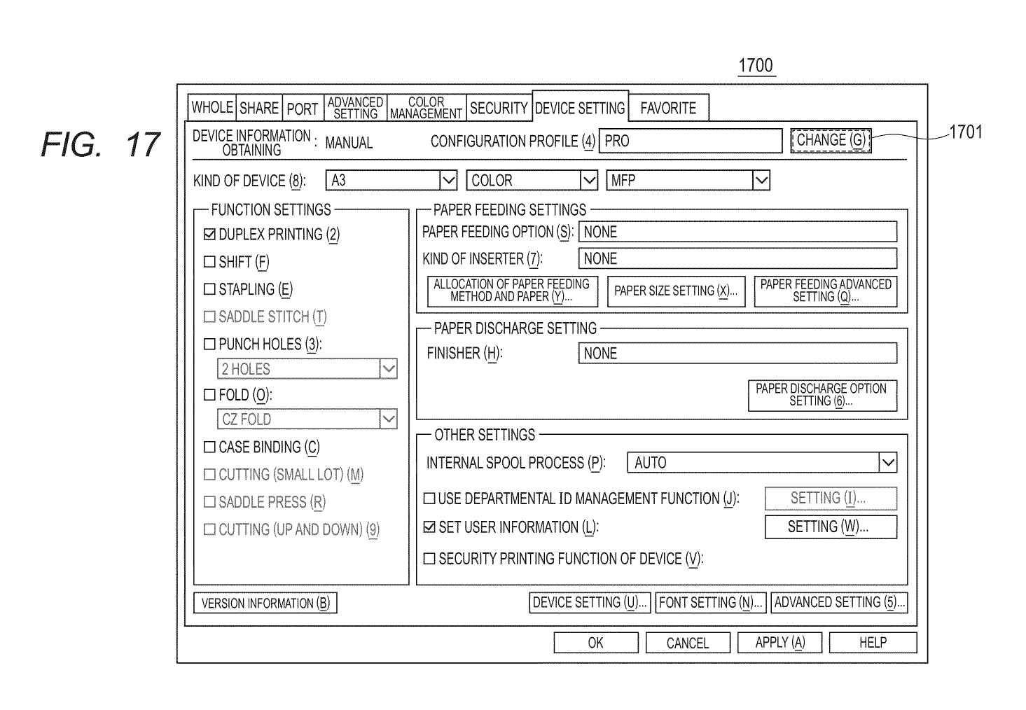

After completion of the foregoing processes, when the user selects the device object and inputs an instruction to display the configuration setting screen, a screen 1700 of FIG. 17 is displayed. That is, in the screen 1700 illustrated in FIG. 17, the configuration profile selected by the screen 1500 illustrated in FIG. 15 has been selected as an initial value. When a change button 1701 illustrated in FIG. 17 is depressed, another configuration profile on the screen 1500 illustrated in FIG. 15 is selected as a choice of other configuration profiles. If information showing that a stapling, a punch, a folding process, or the like can be executed is included in the configuration information of the printer obtained by the printer driver 301, a check box of a shift, a stapling, and punch holes on the screen 1700 illustrated in FIG. 17 are automatically checked.

On the other hand, if the installing process of the printer driver 301 has been executed in a state where “automatic selection” was selected on the screen 1500 illustrated in FIG. 15, the printer driver 301 executes the following process. That is, the printer driver 301 automatically selects the configuration profile, as an initial value, adapted to the configuration information of the printer obtained by the foregoing process.

### Fourth Embodiment

Subsequently, the fourth embodiment will be described.

In the embodiment, when the printer driver 301 is installed, the configuration settings set on the configuration setting screen are formed as a new device type, and this device type is displayed in the device type selecting pull-down menu 401. As mentioned above, in the embodiment, the following construction and processes are added to the first and second embodiments. That is, the following construction and processes are added to the first and second embodiments. That is, such construction and processes that when the printer driver 301 is installed, the current configuration settings are formed as a new device type, and this device type is displayed in the device type selecting pull-down menu 401 are added. Therefore, in the description of the embodiment, substantially the same portions as those in the first and second embodiments are designated by the same reference numerals as those in FIGS. 1 to 13B and their detailed description is omitted.

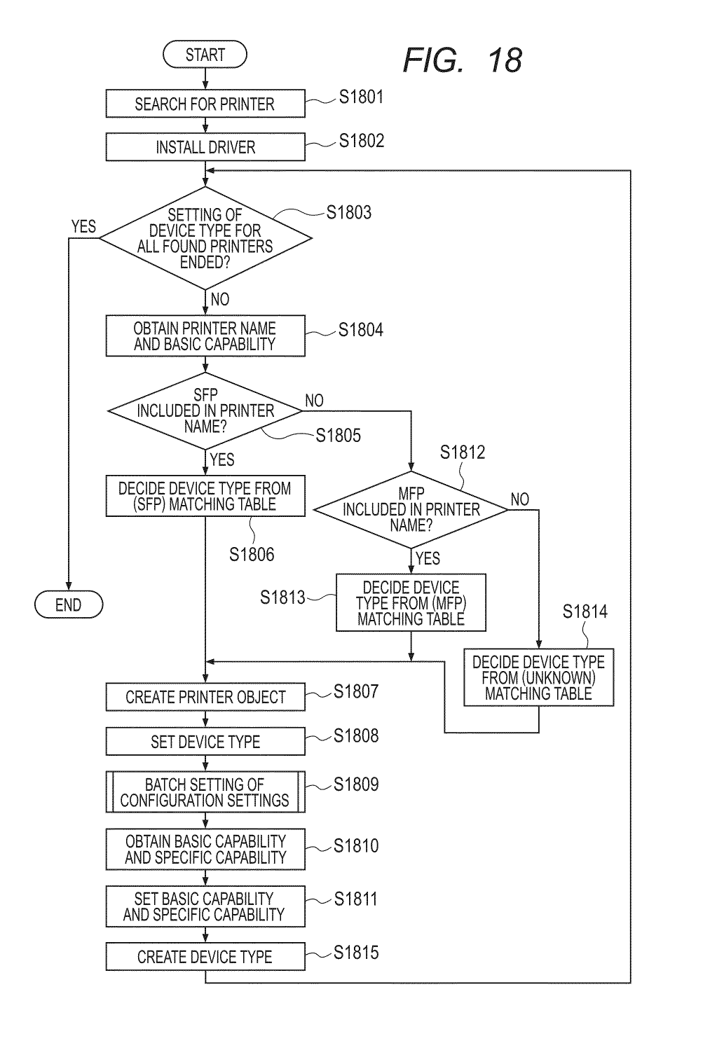

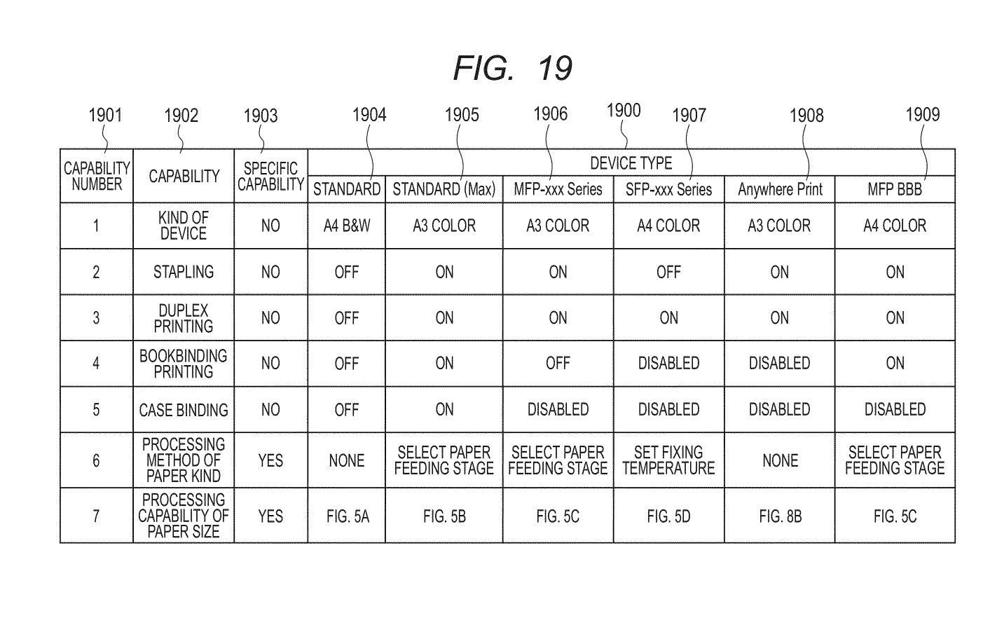

FIG. 18 is a flowchart for describing an example of a process at the time of installing the printer driver 301. When the operation to activate the driver installer 302 is executed, the flowchart of FIG. 18 is started. Processes in steps S1801 to S1814 are substantially the same as those in steps S1001 to S1014 in FIG. 10.

In step S1815, the driver installer 302 instructs the printer driver 301 so as to form the current configuration settings as a new device type. The printer driver 301 which received such an instruction reads the current configuration settings and forms such settings as a new device type. The formed new device type is displayed to the device type selecting pull-down menu 401.

Even in the flowchart of FIG. 12, subsequent to step S1221, by executing the same process as that of step S1815, even if the construction of the second embodiment is used, the current configuration settings can be formed as a new device type.

For example, it is now assumed that the host computer 1000 was connected to the printer 2000 in which the printer name is equal to “MFP BBB” and the kind of device is equal to “A4 Color” and which has the capabilities of stapling, duplex printing, and bookbinding printing and that the printer driver 301 was installed. As mentioned above, it is assumed that only the basic capability was obtained and the specific capability was not obtained. In this case, “MFP BBB” 1909 illustrated in FIG. 19 is formed as a new device type 1900.

That is, since the capabilities in which a capability number 1901 of “MFP BBB” 1909 is equal to “6” and “7” are not obtained in step S1810, a value of “MFP-xxx Series” 1906 is set as a value of “MFP BBB” 1909.

By the batch-setting of the configuration settings, the capability (case binding) in which the capability number 1901 of “MFP-xxx Series” 1906 is equal to “5” is disabled. Therefore, the capability in which the capability number 1901 of “MFP BBB” 1909 is equal to “5” is disabled irrespective of a result of the discrimination about whether or not the capabilities have been obtained in step S1810. As other values of the configuration settings of “MFP BBB” 1909, the capabilities set in step S1810 are set.

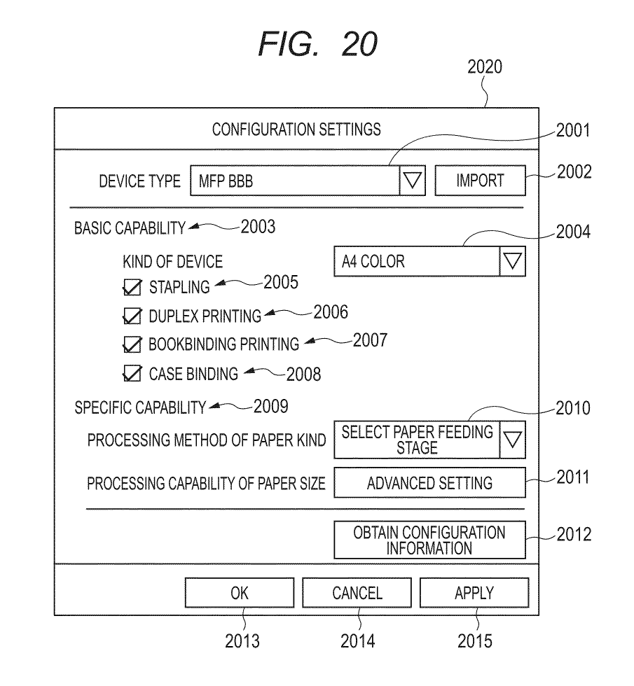

If “MFP BBB” 1909 is registered as a new device type 1900 as mentioned above, the configuration setting screen of “MFP BBB” 1909 becomes a configuration setting screen 2020 as illustrated in FIG. 20.

If all of the capabilities obtained in step S1810 and the capabilities set by the configuration settings which were batch-set in step S1809 are equal, at least one of steps S1811 and S1815 may be omitted.

The capability number 1901, a capability 1902, and a specific capability 1903 are, for example, those described above with reference to FIG. 7. This is true of “STANDARD” 1904, “STANDARD (Max)” 1905, “MFP-xxx Series” 1906, “SFP-xxx Series” 1907, and “Anywhere Print” 1908. A pull-down menu 2001 to select a device type, an import button 2002 of a device type, a basic capability display column 2003, a specific capability display column 2009, and a button 2012 to obtain configuration information are, for example, those described above with reference to FIGS. 4A to 4D. This is true of an OK button 2013, a cancel button 2014, and an update button 2015. Information similar to those in FIGS. 4A to 4D is displayed to the basic capability display column 2003. That is, a pull-down menu 2004 to select a kind, a check box 2005 to select a stapling, a check box 2006 to select the duplex printing, a check box 2007 to select a bookbinding printing, and a check box 2008 to select a case binding are displayed. Further, in a manner similar to FIGS. 4A to 4D, a pull-down menu 2010 to select a processing method of a paper kind and a button 2011 for an advanced setting of a processing capability of a paper size are displayed in the specific capability display column 2009.

The foregoing embodiments are nothing but examples to embody the invention and a technical scope of the invention should not be limitedly interpreted. That is, the invention can be embodied in various forms without departing from its technical idea or its principal features.

### Other Embodiments

The invention is also realized by executing the following processes. That is, first, software (computer program) to realize the functions of the foregoing embodiments is supplied to a system or apparatus through a network or various kinds of storage media. A computer (or CPU, MPU, or the like) of the system or apparatus reads out and executes the computer program.

According to the above-described embodiments, the functions of the image forming apparatus of unknown specifications can be supported by the universal device driver as much as possible.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-259445, filed Dec. 16, 2013, and Japanese Patent Application No. 2014-137015, filed Jul. 2, 2014 which are hereby incorporated by reference herein in their entirety.

What is claimed is:

1. An information processing apparatus having an installing unit configured to install a device driver for generating control commands to a plurality of kinds of image forming apparatuses having different functions, wherein:
the installing unit has
a deciding unit configured to decide a kind of the image forming apparatus connected so that it can communicate,
a selecting unit configured to select device configuration type information corresponding to the decided kind of the image forming apparatus, and
a setting unit configured to set the selected device configuration type information; and
the device configuration type information includes information of functions which can be used in the image forming apparatus.

2. An apparatus according to claim 1, further comprising a holding unit configured to hold the device configuration type information corresponding to each of a plurality of groups which are decided by using the kind of the image forming apparatus, and
wherein the deciding unit decides a group of the image forming apparatus by using the kind of the image forming apparatus connected so that it can communicate, and
the selecting unit selects the device configuration type information corresponding to the decided group of the image forming apparatus.

3. An apparatus according to claim 2, further comprising an instruction setting display unit configured to display an instruction setting display screen which is used to instruct a generation of the control commands and corresponds to the group, and
wherein on the basis of the device configuration type information corresponding to the group, the instruction setting display unit controls the display of the instruction setting display screen corresponding to the group.

4. An apparatus according to claim 2, wherein:
the installing unit further has an obtaining unit configured to obtain the kind of the image forming apparatus and the device configuration type information corresponding to the group of the image forming apparatus; and
when the kind of the image forming apparatus connected so that it can communicate matches with the obtained kind of the image forming apparatus, the selecting unit selects the obtained device configuration type information.

5. An apparatus according to claim 2, further comprising a storing unit configured to store the group which can be selected as the group at the time of installing and the kind of the image forming apparatus so as to be associated with each other, and
wherein on the basis of the kind of the image forming apparatus connected so that it can communicate, the deciding unit selects the group which can be selected as the group of the image forming apparatus at the time of installing.

6. An apparatus according to claim 5, wherein the storing unit stores the group which can be selected as the group at the time of installing, a group which can be selected after the installation, a group which cannot be selected, and the kind of the image forming apparatus so as to be associated with each other.

7. An information processing apparatus for controlling image forming apparatuses by using a device driver for generating control commands to a plurality of kinds of image forming apparatuses having different functions, comprising:
a function setting display unit configured to display a function setting display screen for setting device configuration type information in accordance with the kind of the image forming apparatus; and
an updating unit configured to update in such a manner that when the device configuration type information corresponding to the kind of the image forming apparatus is changed by using the function setting display screen, the device configuration type information corresponding to the kind of the image forming apparatus is updated on the basis of a result of the change,
wherein the device configuration type information includes information of functions which can be used in the image forming apparatus.

8. An apparatus according to claim 7, further comprising an instruction setting display unit configured to display an instruction setting display screen which is used to instruct a generation of the control commands and corresponds to the kind of the image forming apparatus, and
wherein on the basis of the device configuration type information corresponding to the kind of the image forming apparatus, the instruction setting display unit controls the display of the instruction setting display screen corresponding to the kind of the image forming apparatus.

9. An apparatus according to claim 8, wherein:
the function setting display unit displays a function setting display screen for setting the device configuration type information every plurality of groups which are determined by using the kind of the image forming apparatus; and
the instruction setting display unit displays the instruction setting display screen which is used to instruct a generation of the control commands and corresponds to the group.

10. An apparatus according to claim 9, wherein the function setting display unit controls the display of the function setting display screen in such a manner that on the function setting display screen for setting the device configuration type information corresponding to the group, the device configuration type information which does not correspond to the group cannot be set.

11. An apparatus according to claim 9, further comprising a holding unit configured to hold the device configuration type information corresponding to each of the plurality of groups, and
wherein the function setting display screen includes a display to receive a change of the group, and
when the change of the group is received, the updating unit updates the device configuration type information corresponding to the group before the change to the device configuration type information corresponding to the group after the change in a batch manner.

12. An apparatus according to claim 8, wherein the function setting display screen includes a display of an item of the function information and a display to receive a designation of contents of the item.

13. An apparatus according to claim 12, wherein the function setting display screen further includes a display to receive a selection of the item of the function information.

14. An information processing method having an installing step of installing a device driver for generating control commands to a plurality of kinds of image forming apparatuses having different functions, wherein:
the installing step has
a deciding step of deciding a kind of the image forming apparatus connected so that it can communicate,
a selecting step of selecting device configuration type information corresponding to the decided kind of the image forming apparatus, and
a setting step of setting the selected device configuration type information; and
the device configuration type information includes information of functions which can be used in the image forming apparatus.

15. An information processing method of controlling image forming apparatuses by using a device driver for generating control commands to a plurality of kinds of image forming apparatuses having different functions, comprising:
a function setting display step of displaying a function setting display screen for setting device configuration type information in accordance with the kind of the image forming apparatus; and
an updating step of updating in such a manner that when the device configuration type information corresponding to the kind of the image forming apparatus is changed by using the function setting display screen, the device configuration type information corresponding to the kind of the image forming apparatus is updated on the basis of a result of the change,
wherein the device configuration type information includes information of functions which can be used in the image forming apparatus.

16. A non-transitory storage medium storing a computer program for causing a computer to execute steps including an installing step of installing a device driver for generating control commands to a plurality of kinds of image forming apparatuses having different functions, wherein:
the installing step has
a deciding step of deciding a kind of the image forming apparatus connected so that it can communicate,
a selecting step of selecting device configuration type information corresponding to the decided kind of the image forming apparatus, and
a setting step of setting the selected device configuration type information; and
the device configuration type information includes information of functions which can be used in the image forming apparatus.

17. A non-transitory storage medium storing a computer program for causing a computer to control image forming apparatuses by using a device driver for generating control commands to a plurality of kinds of image forming apparatuses having different functions, wherein:
the computer program causes the computer to execute
a function setting display step of displaying a function setting display screen for setting device configuration type information in accordance with the kind of the image forming apparatus and
an updating step of updating in such a manner that when the device configuration type information corresponding to the kind of the image forming apparatus is changed by using the function setting display screen, the device configuration type information corresponding to the kind of the image forming apparatus is updated on the basis of a result of the change; and
the device configuration type information includes information of functions which can be used in the image forming apparatus.
